(19) United States
(12) Patent Application Publication
(10) Pub. No.: US 2013/0013346 A1
(43) Pub. Date: Jan. 10, 2013

(54) SYSTEMS AND METHODS FOR PRODUCT CONFIGURATION

(75) Inventors: John P. O'Connor, Granby, CT (US); Randall P. Horsburgh, Bel Air, MD (US)

(73) Assignee: THE TRAVELERS INDEMNITY COMPANY, Hartford, CT (US)

(21) Appl. No.: 13/542,705

(22) Filed: Jul. 6, 2012

Related U.S. Application Data
(60) Provisional application No. 61/506,091, filed on Jul. 9, 2011.

(51) Int. Cl. G06Q 40/08

(52) U.S. Cl. 705/4

(57) ABSTRACT

Systems, apparatus, interfaces, methods, and articles of manufacture that provide for product configuration.

### CROSS-REFERENCE TO RELATED APPLICATIONS

The present application is a non-provisional of, and claims benefit and priority under 35 U.S.C. §119(e) to, U.S. Provisional Patent Application No. 61/506,091 filed on Jul. 9, 2011 and titled “SYSTEMS AND METHODS FOR PRODUCT CONFIGURATION”, the entirety of which is hereby incorporated by reference herein.

### BACKGROUND

Underwriters, distributors, agents, or sellers of various products (such as insurance or surety products) typically must navigate a series of complex menu options and product configuration possibilities when preparing a quote for a desired product. Often, the selected options are not available and/or may be inappropriate for a particular customer and/or product. Improper product configuration may lead to various adverse consequences such as increased occurrence of losses (e.g., for the underwriter and/or insurer), “premium leakage” (e.g., cases where a policy should have been written for a higher premium—if configured correctly), and/or a distortion of business segment data (which is utilized to determine appropriate premium levels for future underwriting). These and other deficiencies remain unresolved

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3A is a flow diagram of a method according to some embodiments;

FIG. 3B is an example interface according to some embodiments;

FIG. 4 is a flow diagram of a method according to some embodiments;

FIG. 5 is a flow diagram of a method according to some embodiments;

FIG. 6 is a flow diagram of a method according to some embodiments;

FIG. 7 is a flow diagram of a method according to some embodiments;

FIG. 8A, FIG. 8B, FIG. 8C, FIG. 8D, FIG. 8E, and FIG. 8F are example interfaces according to some embodiments;

FIG. 9A, FIG. 9B, FIG. 9C, FIG. 9D, FIG. 9E, FIG. 9F, FIG. 9G, FIG. 9H, FIG. 9I, FIG. 9J, FIG. 9K, FIG. 9L, FIG. 9M, and FIG. 9N are example interfaces according to some embodiments;

FIG. 10 is a block diagram of an apparatus according to some embodiments; and

FIG. 11A, FIG. 11B, FIG. 11C, and FIG. 11D are perspective diagrams of example data storage devices according to some embodiments.

### DETAILED DESCRIPTION

Embodiments described herein are descriptive of systems, apparatus, interfaces, methods, and articles of manufacture for product configuration. In some embodiments, for example, the process of underwriting (e.g., quoting and/or selling) various products may be enhanced by application of rules, logic, and/or guidelines that automatically present appropriate product configuration options and/or that automatically configure one or more products. In some embodiments, product configuration may be based on location information such as via geocoding.

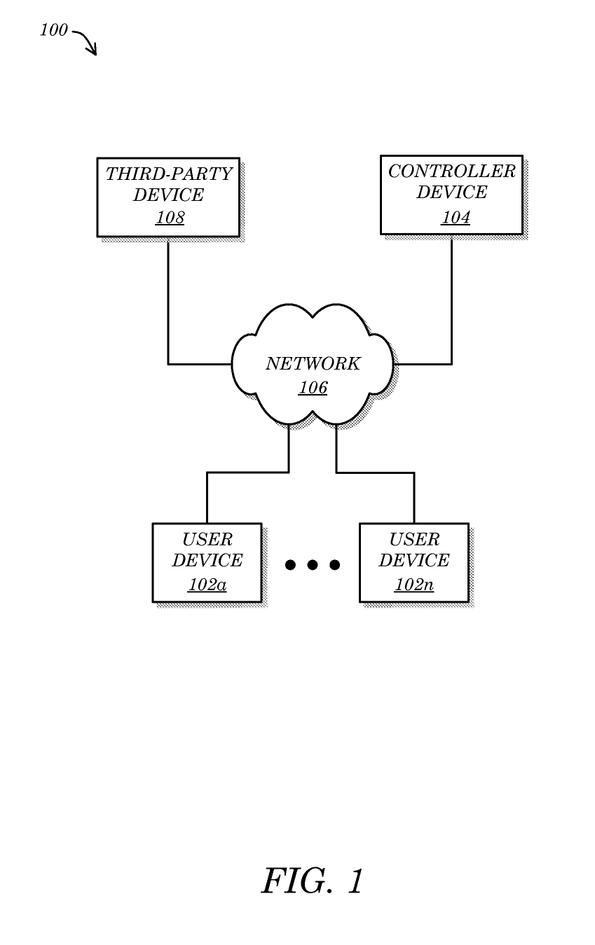

Referring first to FIG. 1, a block diagram of a system 100 according to some embodiments is shown. In some embodiments, the system 100 may comprise a plurality of user devices 102a-n, a controller device 104, a network 106, and/or a third-party device 108. As depicted in FIG. 1, any or all of the devices 102a-n, 104, 108 (or any combinations thereof) may be in communication via the network 106. In some embodiments, the system 100 may be utilized to provide (and/or receive) enhanced (e.g., “smart”) classification of business and/or other data or metrics. The controller device 104 may, for example, interface with one or more of the user devices 102a-n and/or the third-party device 108 to provide automatic business classifications in an effort to make an underwriting process (e.g., conducted and/or initiated by one or more of the user devices 102a-n) more efficient and/or effective. Smart classification systems and methods such as described in U.S. patent application Ser. No. 13/179,464 filed on Jul. 8, 2011 and titled “SYSTEMS AND METHODS FOR BUSINESS CLASSIFICATION”, which are hereby incorporated herein by reference, could for example be utilized as part of a “smart” product configuration process in accordance with embodiments described herein.

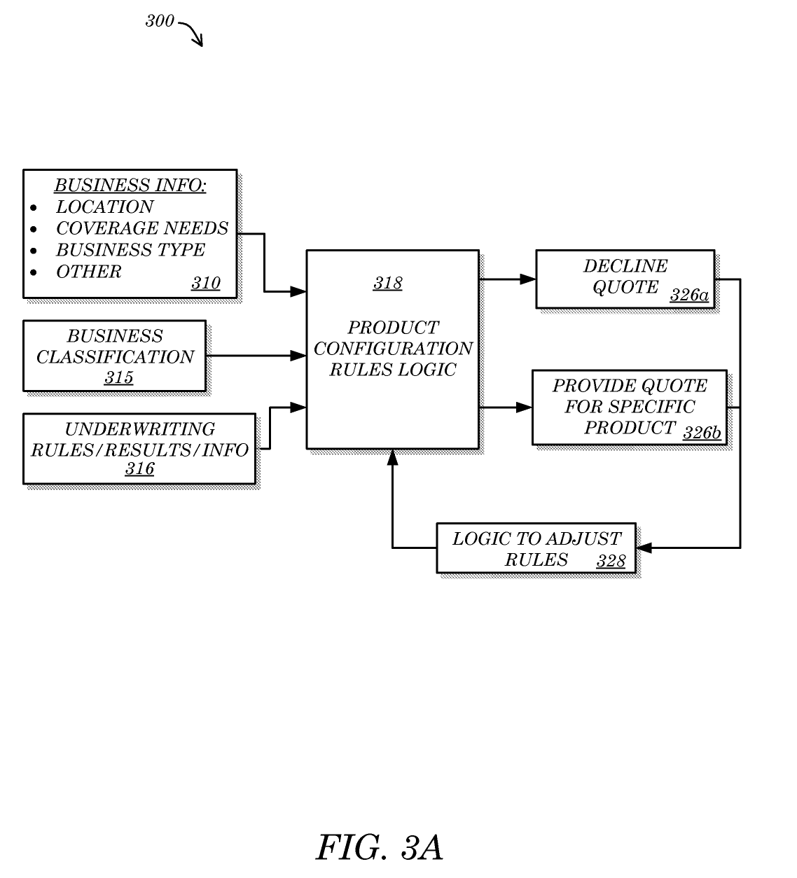

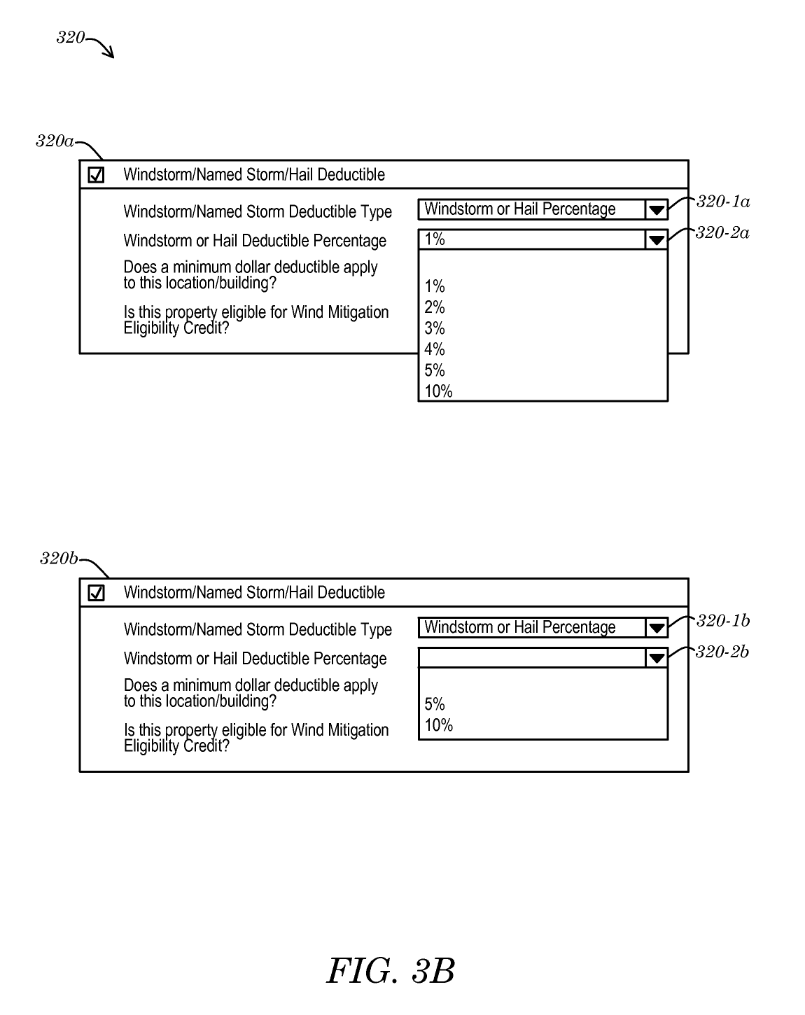

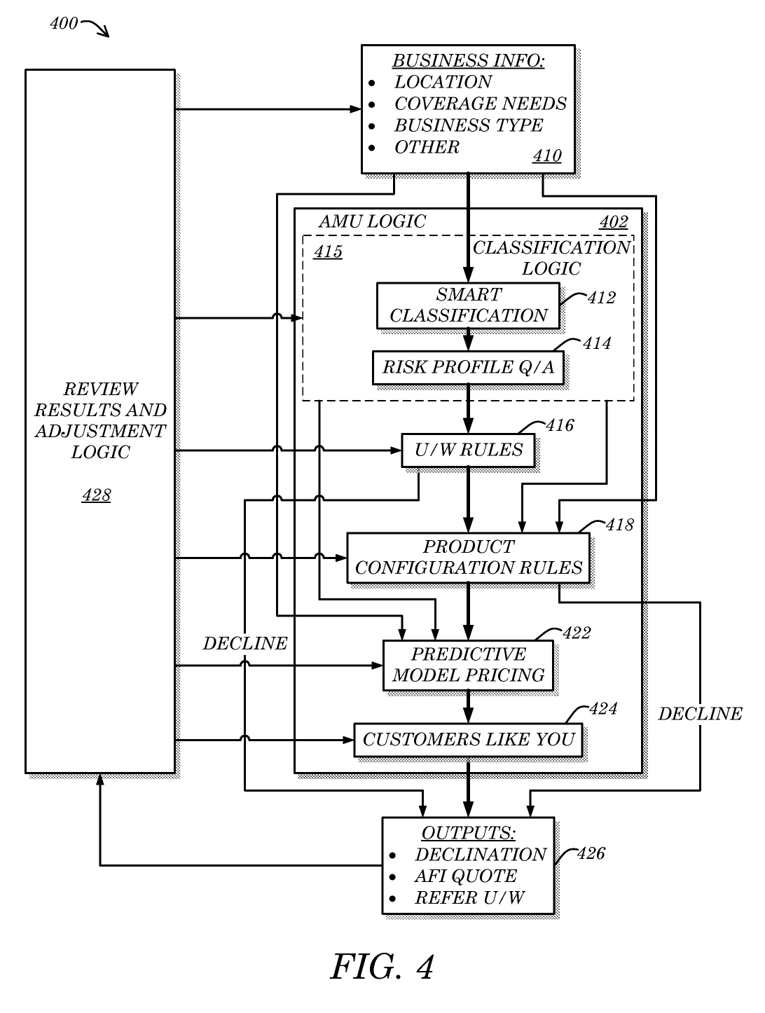

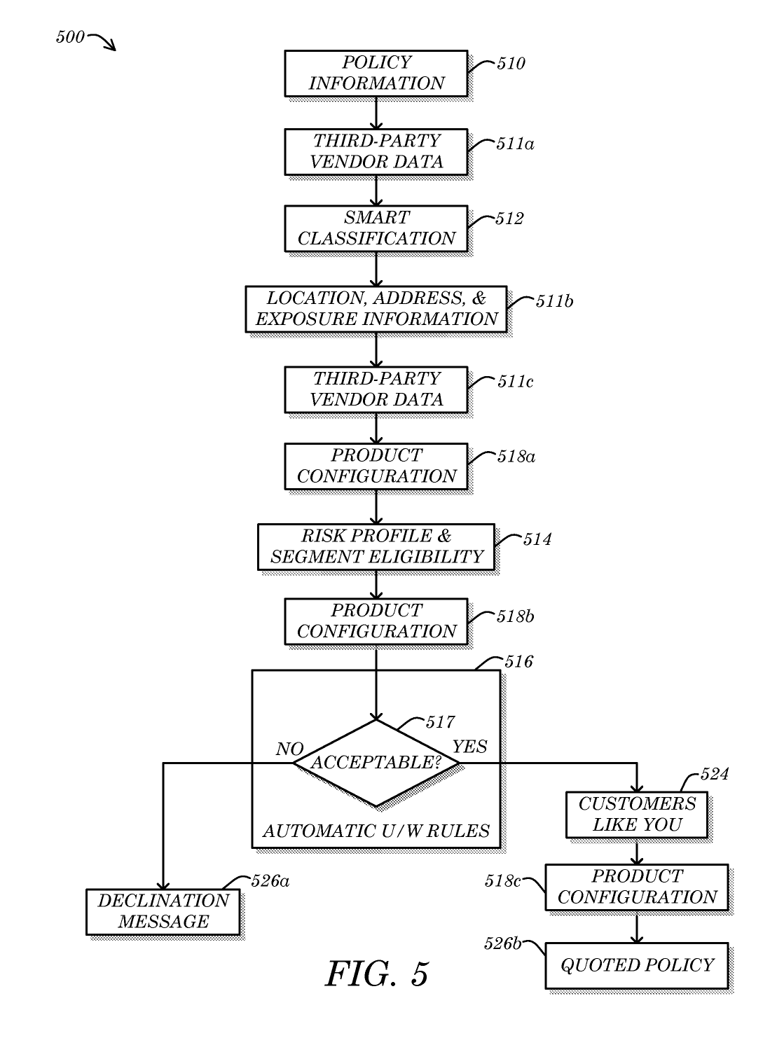

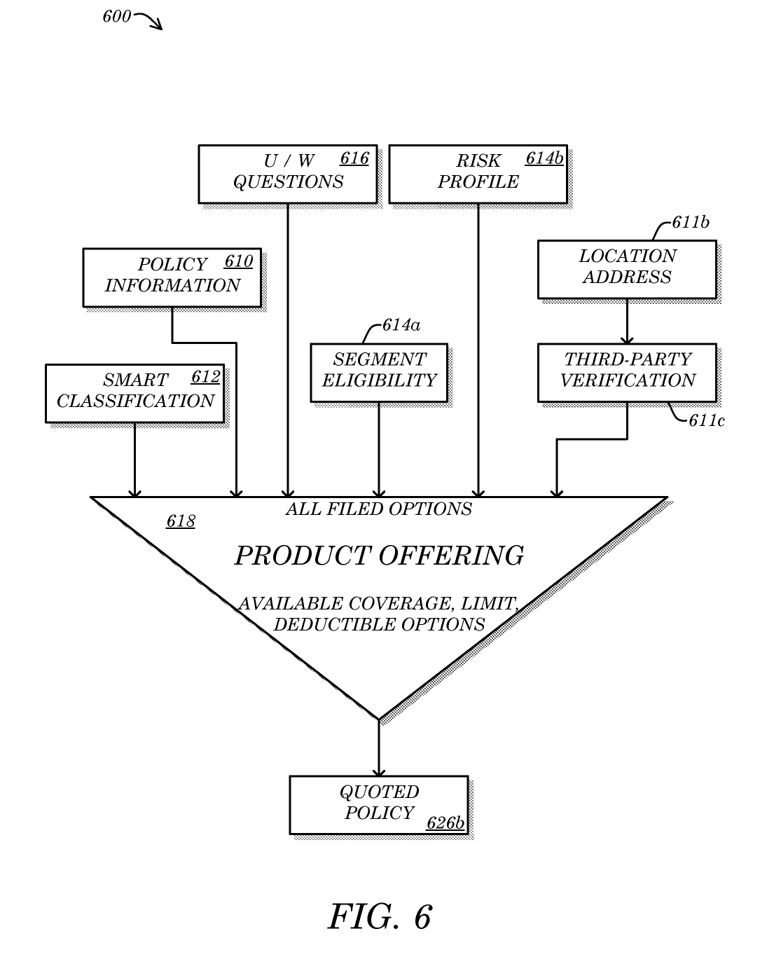

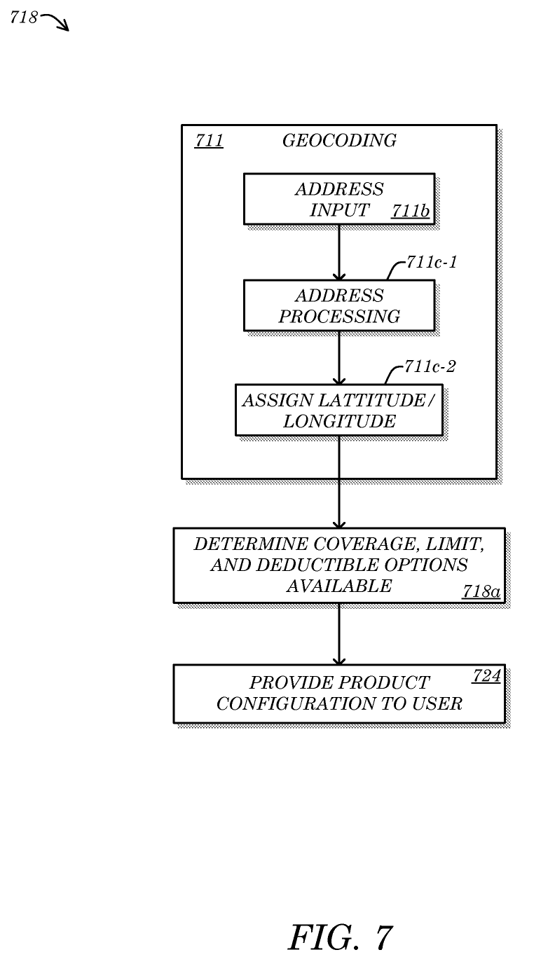

Fewer or more components 102a-n, 104, 106, 108, and/or various configurations of the depicted components 102a-n, 104, 106, 108 may be included in the system 100 without deviating from the scope of embodiments described herein. In some embodiments, the components 102a-n, 104, 106, 108 may be similar in configuration and/or functionality to similarly named and/or numbered components as described herein. In some embodiments, the system 100 (and/or portion thereof) may comprise an underwriting program and/or platform programmed and/or otherwise configured to execute, conduct, and/or facilitate any of the various methods 300, 400, 500, 600, 700 of FIG. 3A, FIG. 4, FIG. 5, FIG. 6, and/or FIG. 7 and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., underwriter workstations), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as underwriters, account managers, agents/brokers, customer service representatives, and/or underwriting product customers. According to some embodiments, the user devices 102a-n may communicate with the controller device 104 via the network 106, such as to conduct underwriting inquiries and/or processes utilizing enhanced or “smart” classifications as described herein. In some embodiments, the user devices 102a-n may interface with the controller device 104 to effectuate communications (direct or indirect) with one or more other user devices 102a-n (such communication not explicitly shown in FIG. 1), such as may be operated by other users. In some embodiments, the user devices 102a-n may interface with the controller device 104 to effectuate communications (direct or indirect) with the third-party device 108 (such communication also not explicitly shown in FIG. 1).

In some embodiments, the controller device 104 may comprise an electronic and/or computerized controller device such as a computer server communicatively coupled to interface with the user devices 102a-n and/or the third-party device 108 (directly and/or indirectly). The controller device 104 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 104 may be located remote from one or more of the user devices 102a-n and/or the third-party device 108. The controller device 104 may also or alternatively comprise a plurality of electronic processing devices located at one or more various sites and/or locations.

According to some embodiments, the controller device 104 may store and/or execute specially programmed instructions to operate in accordance with embodiments described herein. The controller device 104 may, for example, execute one or more programs that facilitate the enhanced or smart classification of underwriting product clients, customers, businesses, products, and/or other associated metrics. According to some embodiments, the controller device 104 may comprise a computerized processing device such as a PC, laptop computer, computer server, and/or other electronic device to manage and/or facilitate transactions and/or communications regarding the user devices 102a-n (e.g., in an attempt to increase the efficiency and effectiveness of underwriting). An underwriter (and/or customer, client, or company) may, for example, utilize the controller device 104 to (i) price and/or underwrite one or more products such as insurance, indemnity, and/or surety products, (ii) determine and/or be provided with business and/or other classification information in an enhanced manner as described herein, (iii) determine and/or be provided with business classification and/or other reclassification based on answers to underwriting questions, and/or (iv) provide an interface via which an underwriting entity may manage and/or facilitate underwriting of various products (e.g., in accordance with embodiments described herein).

The network 106 may, according to some embodiments, comprise a Local Area Network (LAN; wireless and/or wired), cellular telephone, Bluetooth®, and/or Radio Frequency (RF) network with communication links between the controller device 104, the user devices 102a-n, and/or the third-party device 108. In some embodiments, the network 106 may comprise direct communications links between any or all of the components 102a-n, 104, 108 of the system 100. The user devices 102a-n may, for example, be directly interfaced or connected to one or more of the controller device 104 and/or the third-party device 108 via one or more wires, cables, wireless links, and/or other network components, such network components (e.g., communication links) comprising portions of the network 106. In some embodiments, the network 106 may comprise one or many other links or network components other than those depicted in FIG. 1. The user devices 102a-n may, for example, be connected to the controller device 104 via various cell towers, routers, repeaters, ports, switches, and/or other network components that comprise the Internet and/or a cellular telephone (and/or Public Switched Telephone Network (PSTN)) network, and which comprise portions of the network 106.

While the network 106 is depicted in FIG. 1 as a single object, the network 106 may comprise any number, type, and/or configuration of networks that is or becomes known or practicable. According to some embodiments, the network 106 may comprise a conglomeration of different sub-networks and/or network components interconnected, directly or indirectly, by the components 102a-n, 104, 108 of the system 100. The network 106 may comprise one or more cellular telephone networks with communication links between the user devices 102a-n and the controller device 104, for example, and/or may comprise the Internet, with communication links between the controller device 104 and the third-party device 108, for example.

The third-party device 108, in some embodiments, may comprise any type or configuration a computerized processing device such as a PC, laptop computer, computer server, database system, and/or other electronic device, devices, or any combination thereof. In some embodiments, the third-party device 108 may be owned and/or operated by a third-party (i.e., an entity different than any entity owning and/or operating either the user devices 102a-n or the controller device 104). The third-party device 108 may, for example, be owned and/or operated by a data and/or data service provider such as Dun & Bradstreet® Credibility Corporation (and/or a subsidiary thereof, such as Hoovers™), Deloitte® Development, LLC, Experian™ Information Solutions, Inc., and/or Edmunds.com®, Inc. In some embodiments, the third-party device 108 may supply and/or provide data such as business and/or other classification data to the controller device 104 and/or the user devices 102a-n. In some embodiments, the third-party deice 108 may comprise a plurality of devices and/or may be associated with a plurality of third-party entities.

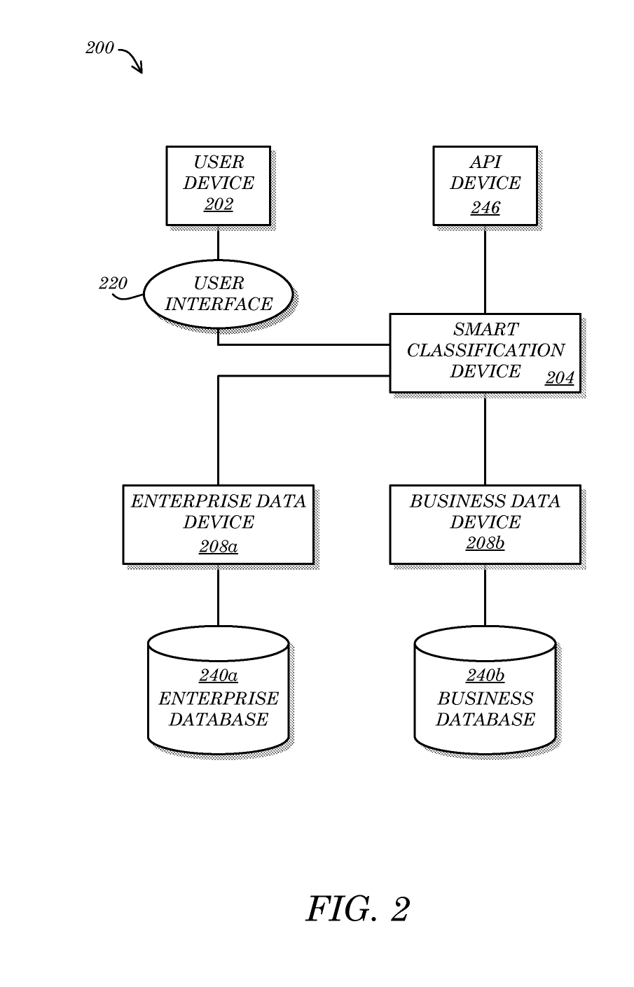

Turning to FIG. 2, a block diagram of a system 200 according to some embodiments is shown. In some embodiments, the system 200 may conduct and/or facilitate smart classification of underwriting metrics. The system 200 may, for example, be similar in configuration and/or functionality to the system 100 of FIG. 1 herein. According to some embodiments, the system 200 may comprise a user device 202 in communication with a smart classification device 204. In some embodiments, the smart classification device 204 may be in communication with one or more data devices 208a-b such as an enterprise data device 208a and/or a business data device 208b. According to some embodiments, the user device 202 may interact, interface, and/or communicate with the smart classification device 204 via a user interface 220. In some embodiments, the enterprise data device 208a may be in communication with (and/or comprise) an enterprise database 240a and/or the business data device 208b may be in communication with (and/or comprise) a business database 240b. According to some embodiments, the system 200 may comprise an Application Program Interface (API) device 246 in communication with the smart classification device 204.

Fewer or more components 202, 204, 208a-b, 220, 240a-b, 246 and/or various configurations of the depicted components 202, 204, 208a-b, 220, 240a-b, 246 may be included in the system 200 without deviating from the scope of embodiments described herein. In some embodiments, the components 202, 204, 208a-b, 220, 240a-b, 246 may be similar in configuration and/or functionality to similarly named and/or numbered components as described herein. In some embodiments, the system 200 (and/or a portion thereof) may comprise an underwriting program and/or platform programmed and/or otherwise configured to execute, conduct, and/or facilitate any of the various methods 300, 400, 500, 600, 700 of FIG. 3A, FIG. 4, FIG. 5, FIG. 6, and/or FIG. 7 and/or portions or combinations thereof described herein.

In some embodiments, the user device 202 may be utilized (e.g., by a user; not shown) to access the user interface 220. The user interface 220 may, for example, comprise a Graphical User Interface (GUI) such as a web page, form, and/or API provided by (and/or otherwise associated with) the smart classification device 204. According to some embodiments, the user device 202 may comprise a computerized device operated by a user (e.g., an insurance underwriter) (not shown) and/or the smart classification device 204 may comprise a server, program (e.g., a web browser plug-in), and/or application (e.g., an underwriting application) configured to facilitate the underwriting (or pricing) process. The user may, according to some embodiments, provide input via the user device 202 and/or the user interface 220. The input may comprise, for example, an indication of a location such as a customer and/or business location (and/or indications of other underwriting metrics). In some embodiments, the smart classification device 204 may receive and/or process the input to determine a proper classification of the customer, business, and/or other metric.

The smart classification device 204 may, for example, send and/or provide an indication of the location to either or both of the enterprise data device 208a and the business data device 208b. In some embodiments, the smart classification device 204 may transmit a query to either or both of the enterprise data device 208a and the business data device 208b (e.g., based on the location information). In the case that the enterprise data device 208a is utilized, data regarding the particular business may have been previously processed and/or may already be stored in the enterprise database 240a. The enterprise database 240a may, for example, comprise a data storage device of an entity, institution, and/or business (none of which are explicitly shown) that owns and/or operates the smart classification device 204. The entity may, in some embodiments, comprise an insurance company and/or underwriter associated therewith. The enterprise database 240a may comprise, for example, an enterprise data store of the insurance company and/or underwriter. The enterprise data device 208a may, according to some embodiments, comprise a network component, database component, and/or a Database Access Object (DAO) configured to permit and/or facilitate access to the enterprise database 240a.

In some embodiments, the smart classification device 204 may attempt to acquire business classification (and/or other metric classification) data from the enterprise database 240a (e.g., by interfacing with the enterprise data device 208a). In the case that classification data is determined from the enterprise database 240a, the smart classification device 204 may provide the classification data to the user (and/or user device 202) via the user interface 220. According to some embodiments, the enterprise database 240a may also or alternatively store information descriptive of available classifications and/or descriptions thereof. The enterprise database 240a may, for example, store indications of every possible business classification for a particular underwriting company, business unit, and/or underwriting product type. In some embodiments, such as in the case that classification information cannot be located via the enterprise database 240a (and/or the business database 240b), the user device 202 (and/or the user interface 220) may be utilized to search (e.g., query) the possible classifications. In some embodiments, the searching may comprise keyword, “also-known-as” (A.K.A.), search-as-you-type, industry code, and/or industry segment searching. According to some embodiments, the enterprise database 240a may store indications of underwriting questions assigned to one or more classifications. In some embodiments, such underwriting questions may be provided to the user device 202 and/or answers thereto (e.g., provided via the user interface 220) may trigger reclassification based on data stored in the enterprise database 240a.

In some embodiments, such as in the case that classification data cannot be identified and/or determined from the enterprise database 240a, the smart classification device 204 may attempt to acquire business classification (and/or other metric classification) data from the business database 240b (e.g., via the business data device 208b). According to some embodiments, the smart classification device 204 may utilize the location information received via the user interface 220 to search for business classification information utilizing the business data device 208b (e.g., by accessing the business database 240b). The business data device 208b and/or the business database 240b may, for example, comprise devices, data stores, and/or network components owned and/or operated by a third-party entity (and/or a plurality of third-parties; e.g., similar to the third-party device 108 of FIG. 1; the entity not being explicitly shown). Such a third-party entity may, in some embodiments, comprise a commercial service that acquires, aggregates, provides, and/or sells access to various information such as demographics, marketing information, credit ratings (and/or other credit and/or financial information), and/or business classifications (such as Standard Industrial Classification (SIC) codes as published by the U.S. Occupational Health & Safety Administration (OSHA) and/or North American Industrial Classification System (NAICS) codes) data. In such a manner, for example, the smart classification device 204 may utilize the location information provided by the user device 202 to query the business database 240b and determine one or more of a SIC code, NAICS code, and/or other industry, business, and/or business segment classification for a particular client, customer, and/or potential underwriting product sale.

In some embodiments, any program code, rules, communications protocols, and/or definitions, modules, objects, and/or any combination thereof that cause and/or facilitate operation of the smart classification device 204 and/or the user interface 220, may be managed, defined, edited, and/or stored via the API device 246. The API device 246 may, for example, comprise a specially-programmed API, program, application, and/or other function or procedure that facilitates creation, setup, and/or execution or management of an underwriting and/or underwriting product pricing tool. In some embodiments for example, the API device 246 may be utilized to create, define, modify, and/or manage the user interface 220 (and/or programmed instructions that define and/or comprise the user interface 220).

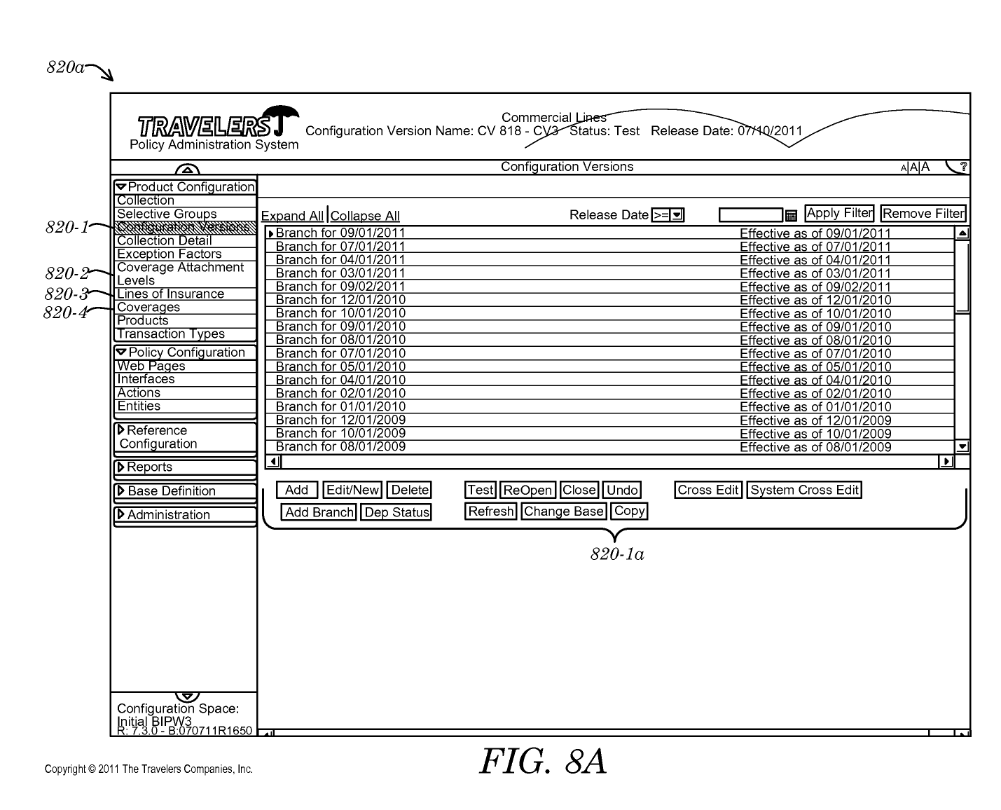

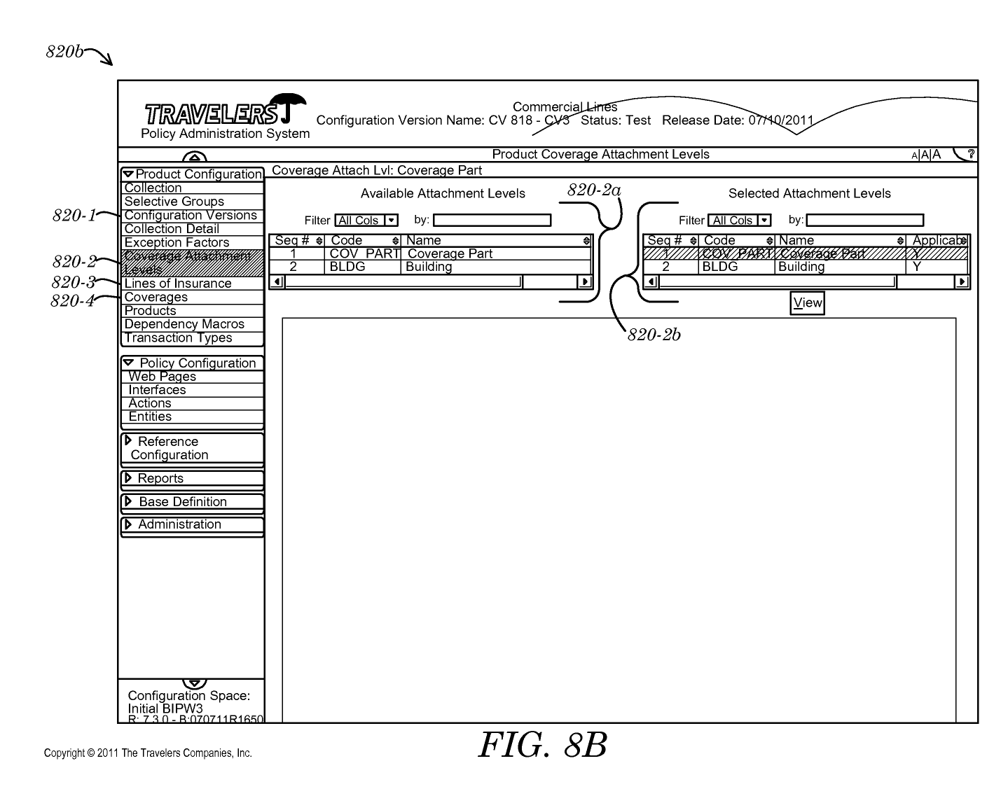

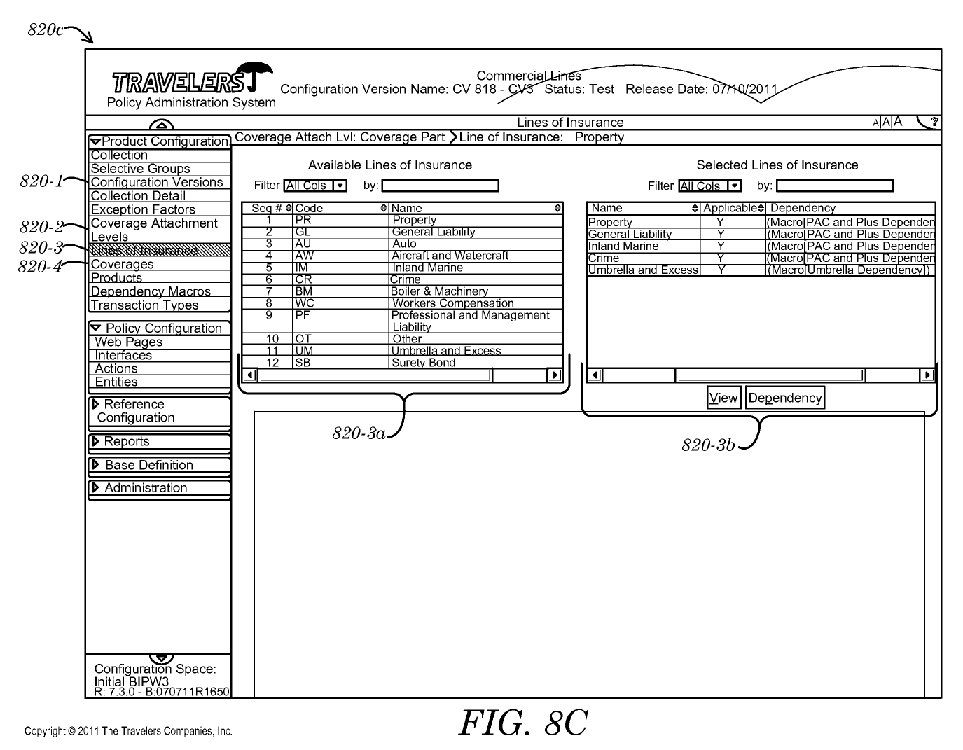

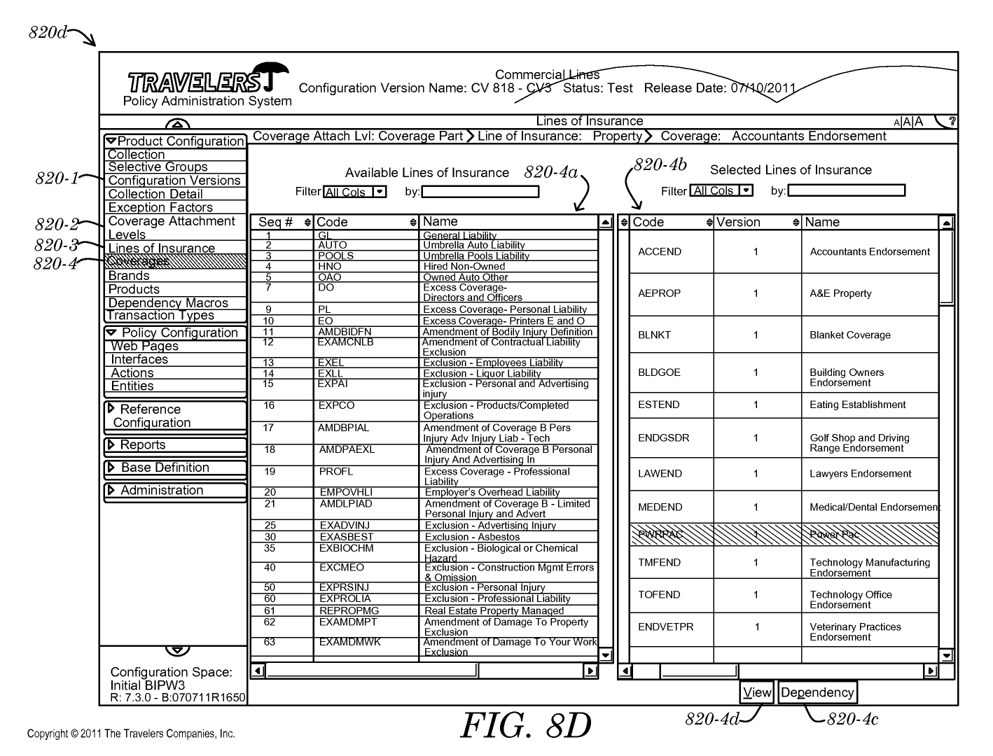

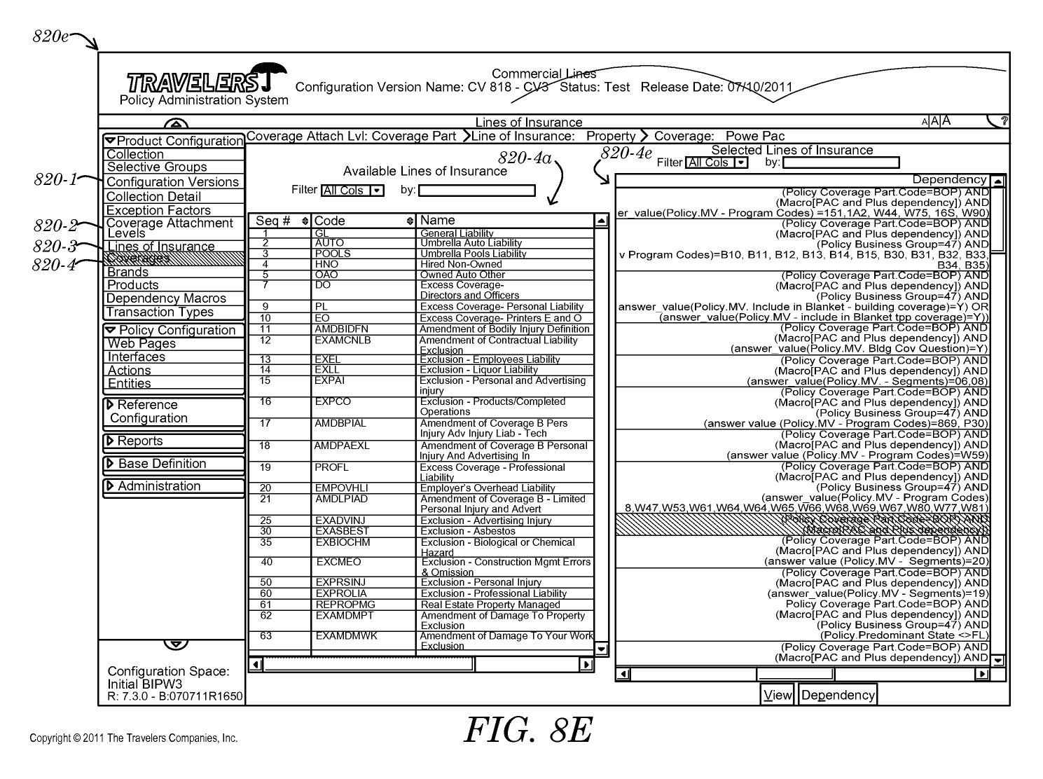

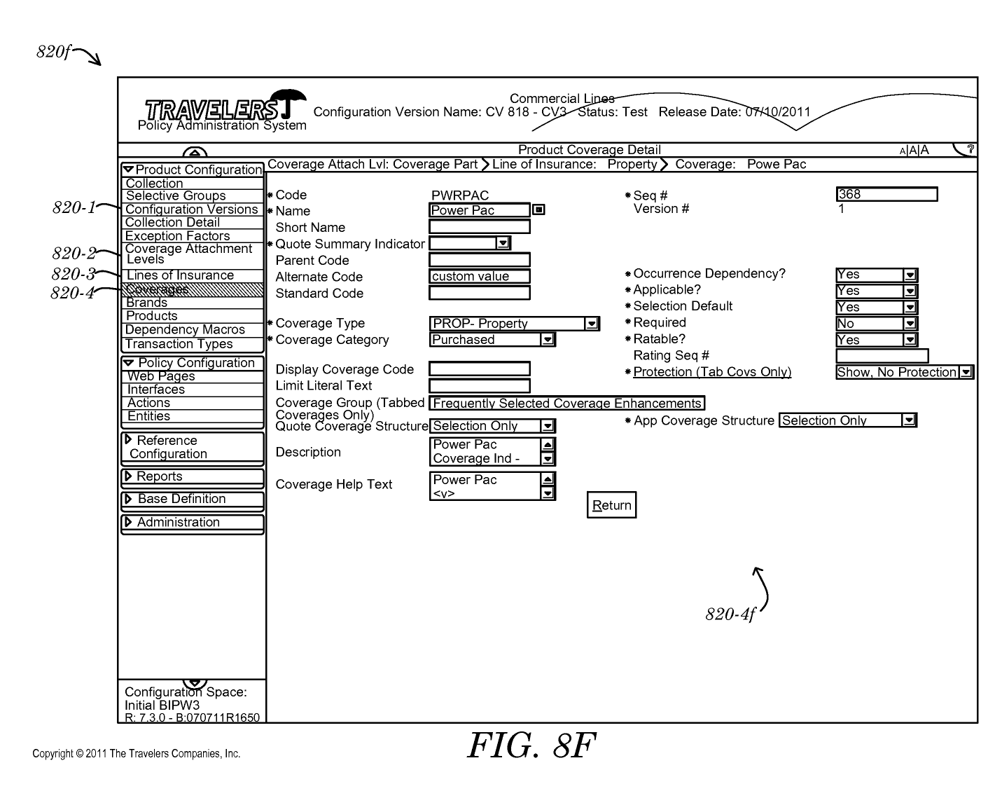

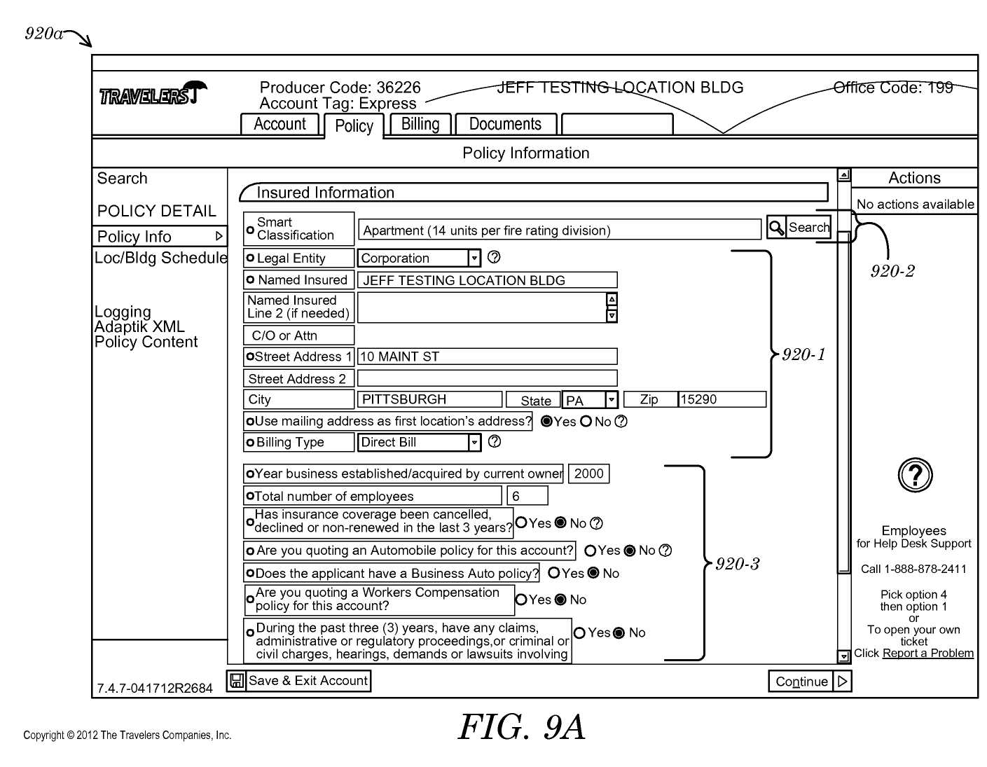

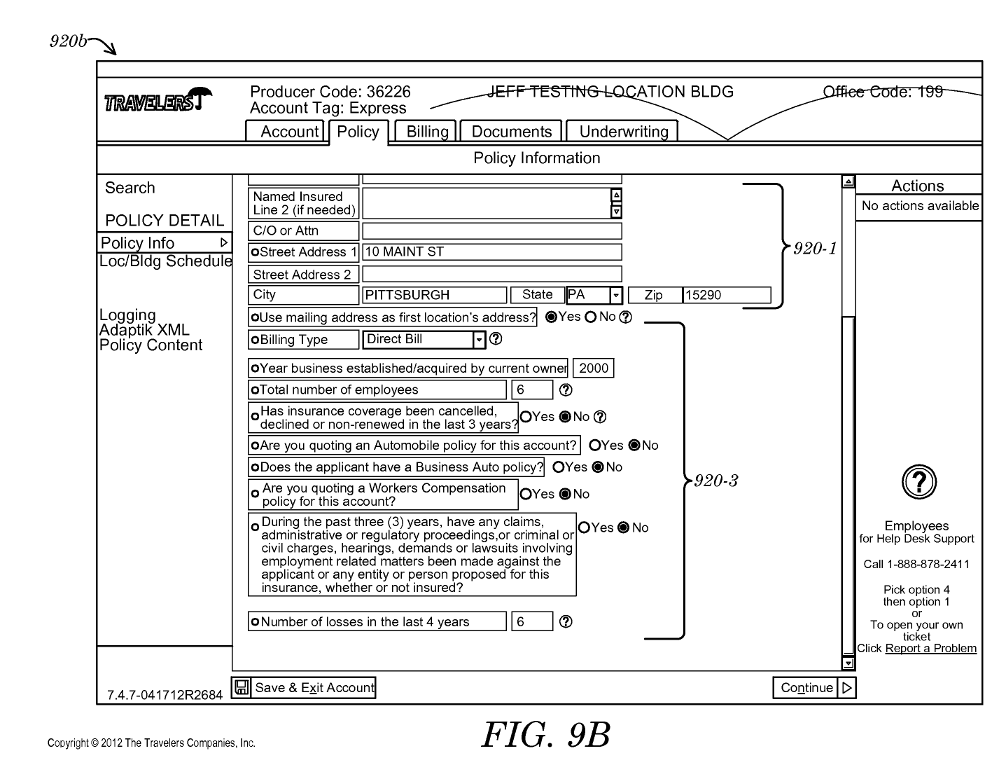

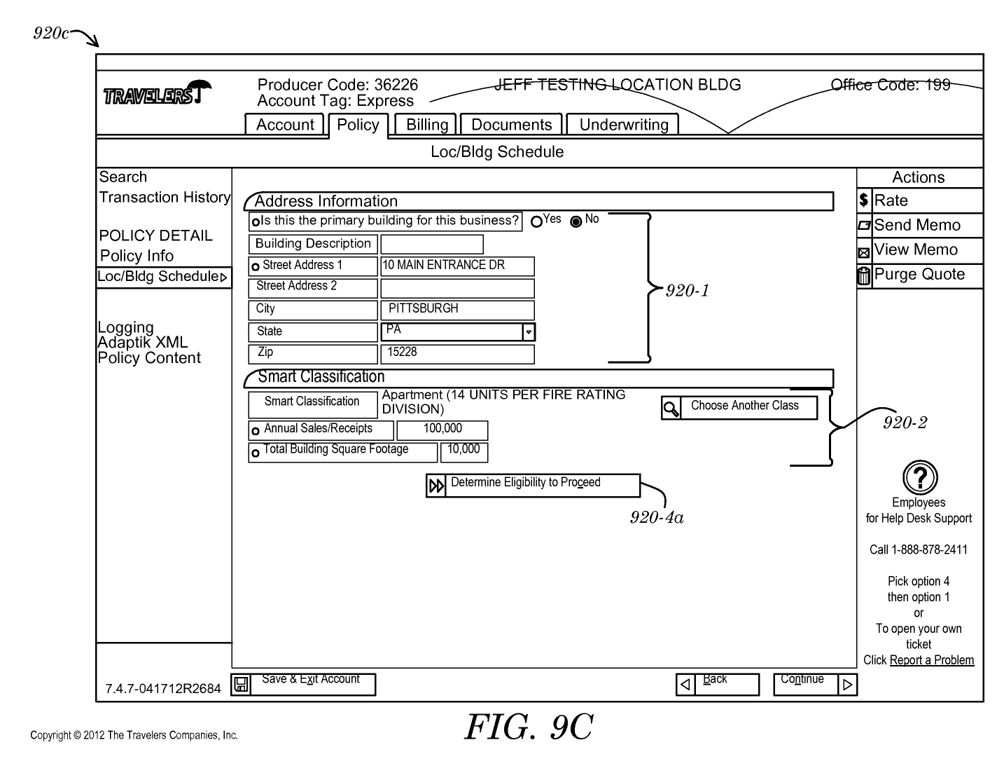

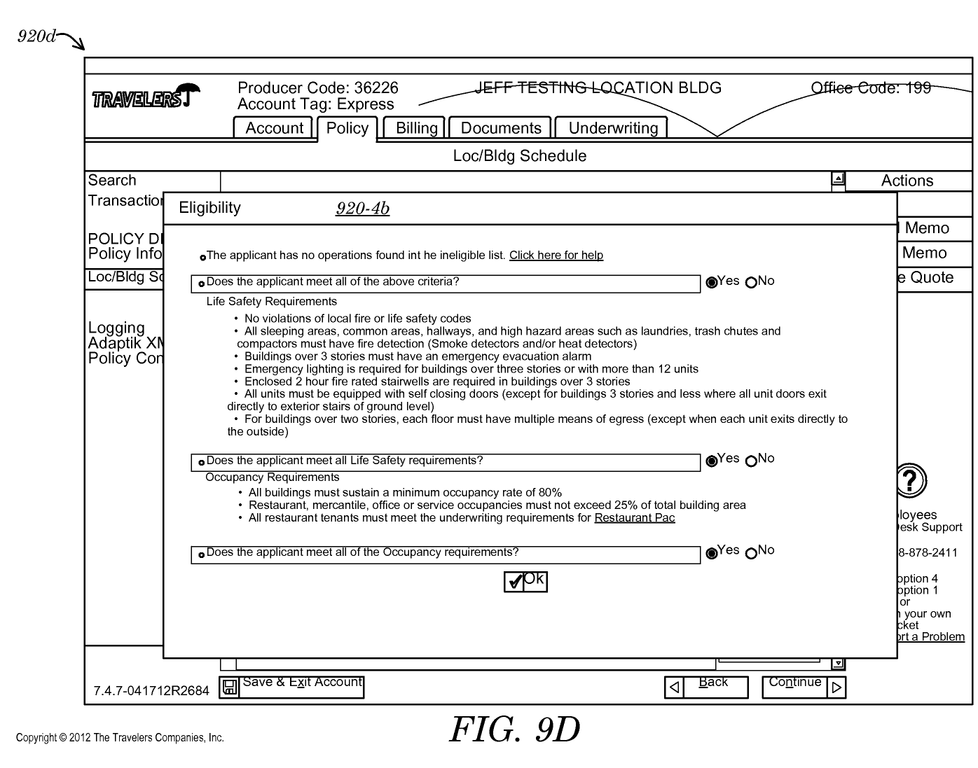

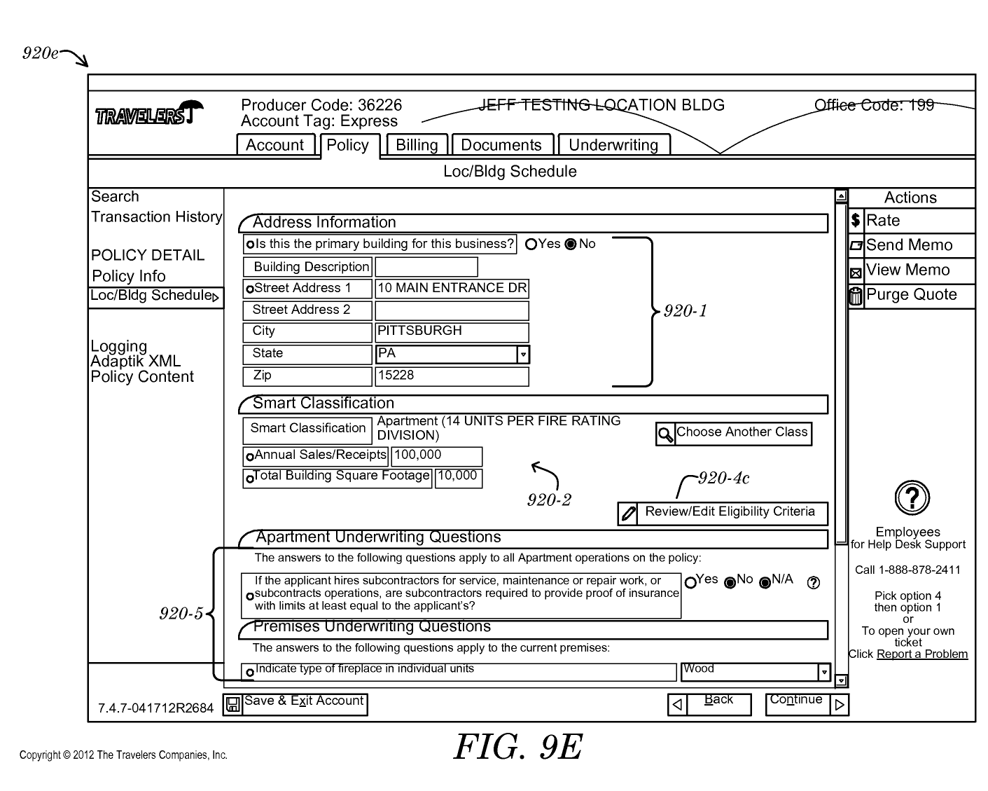

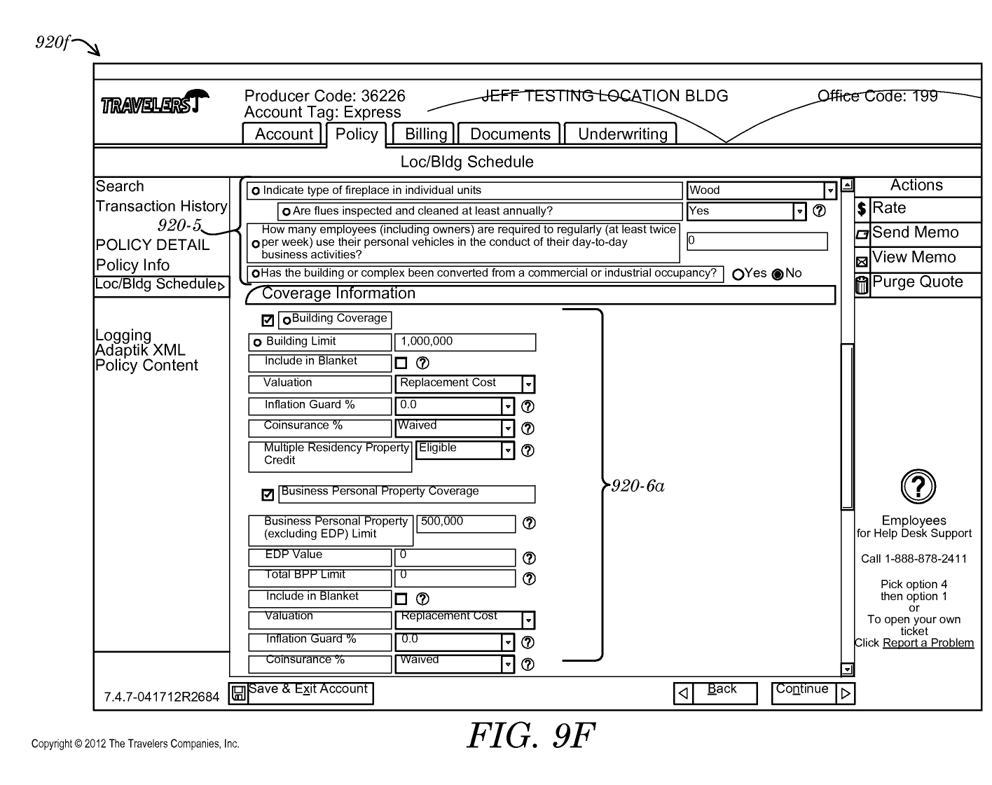

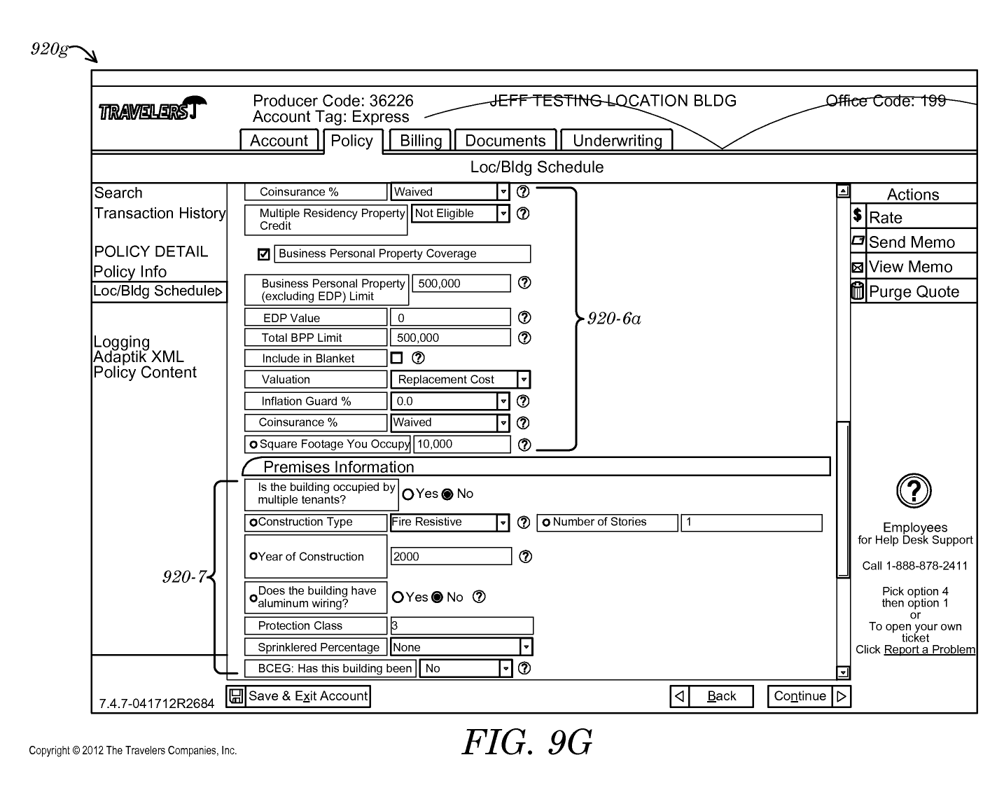

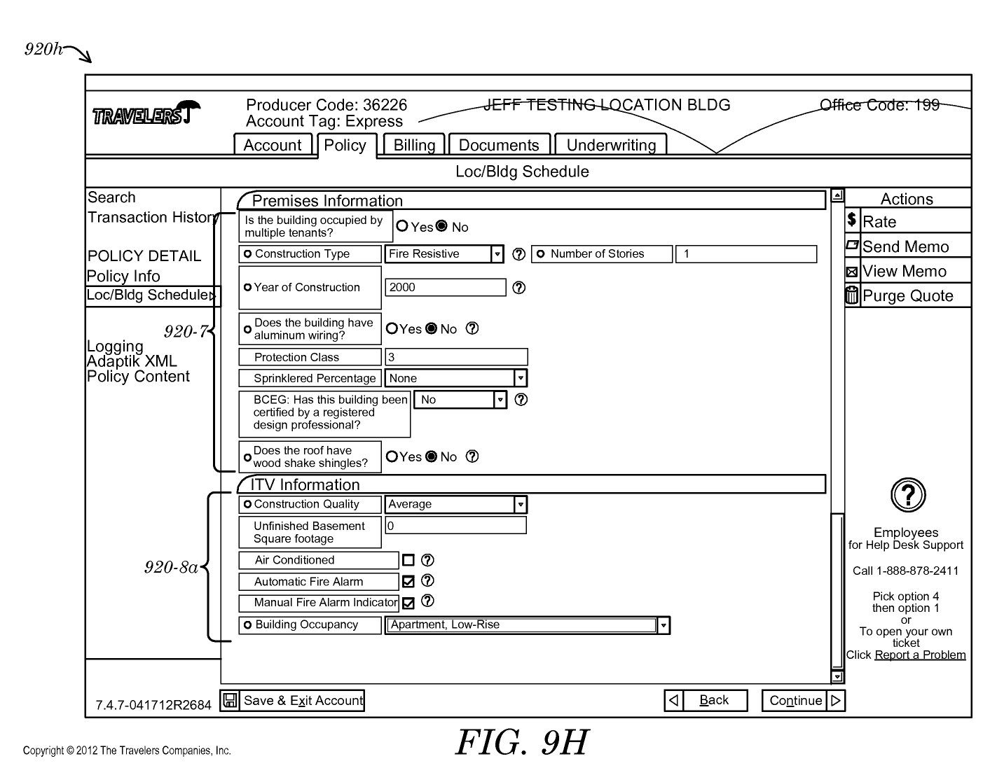

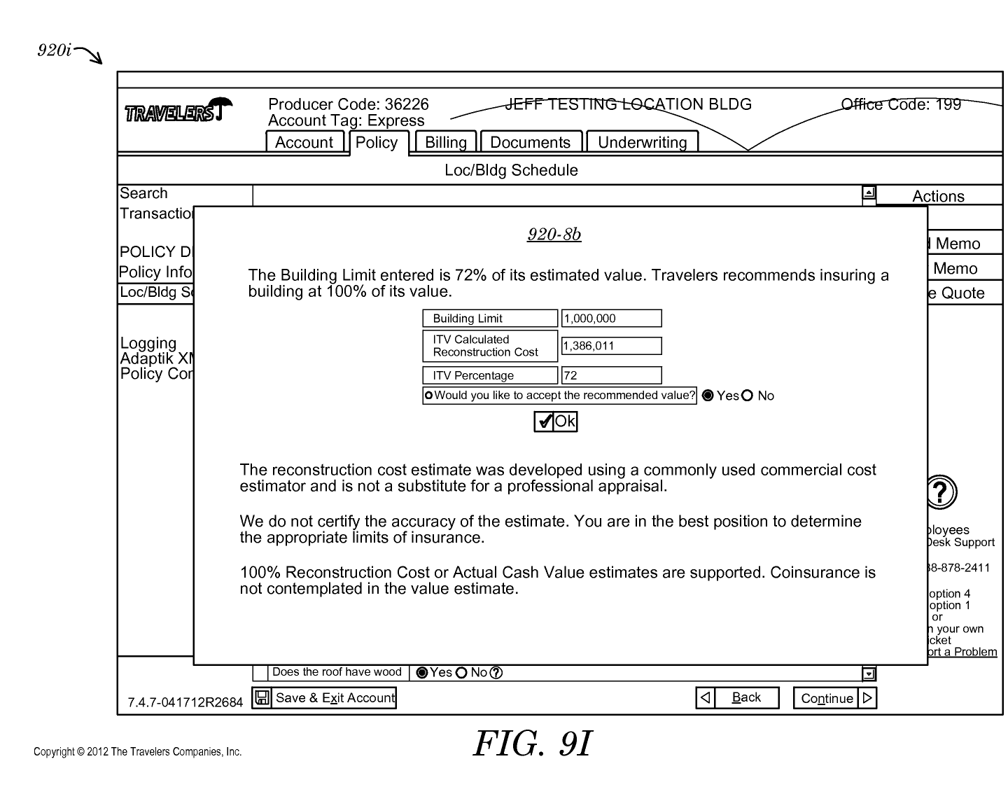

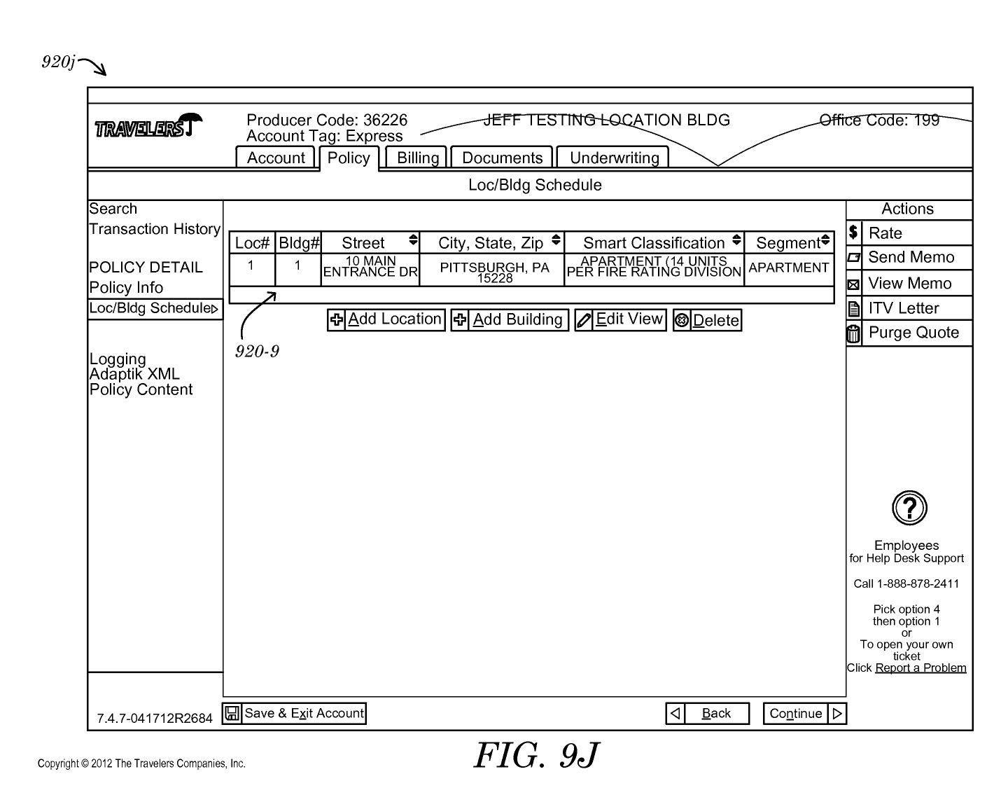

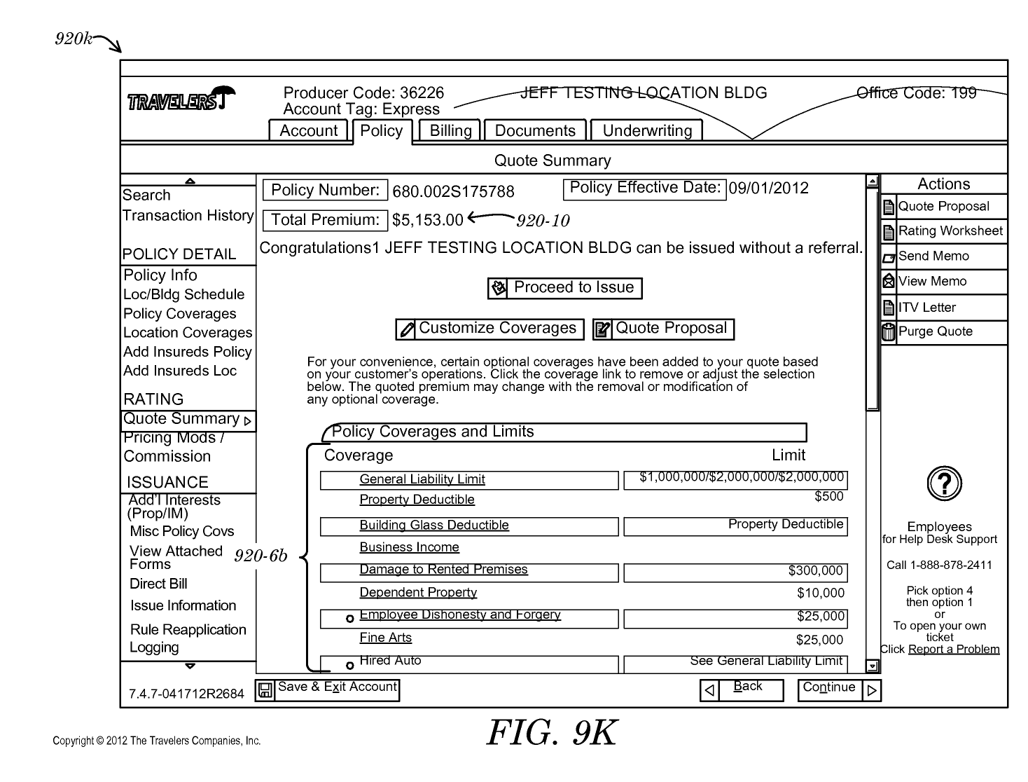

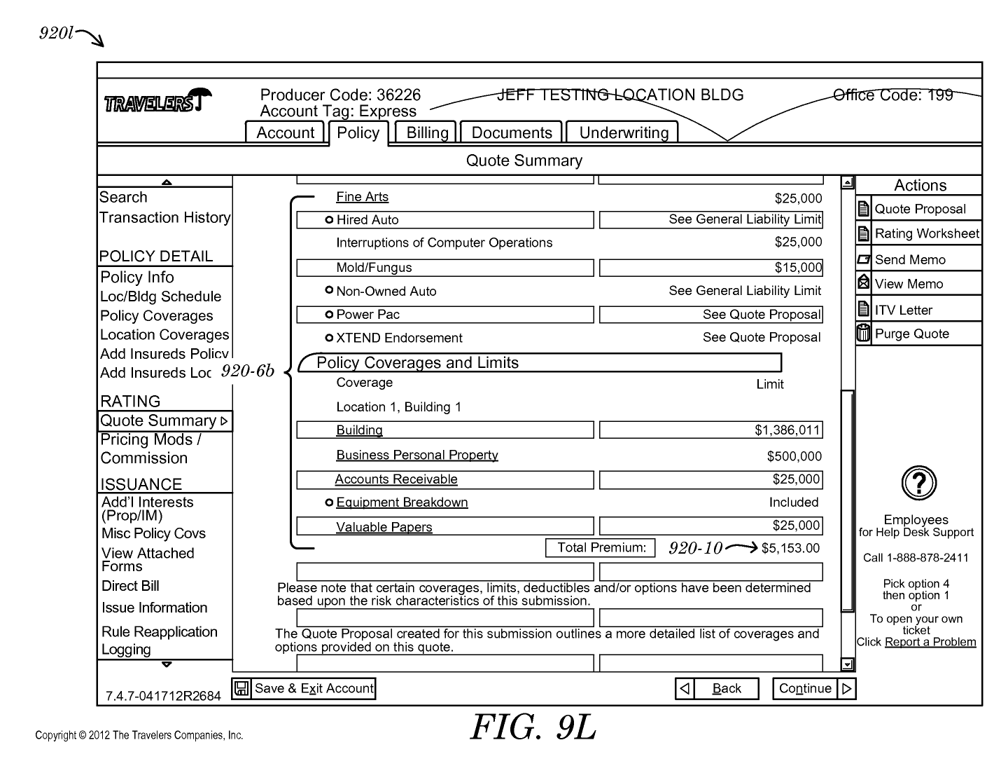

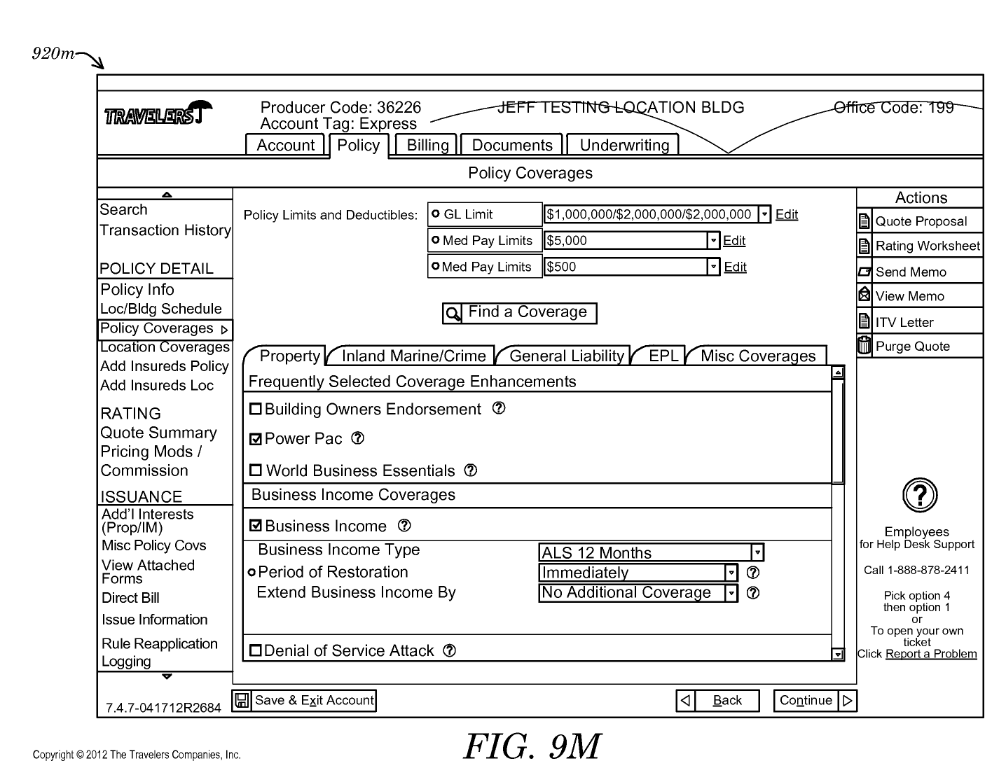

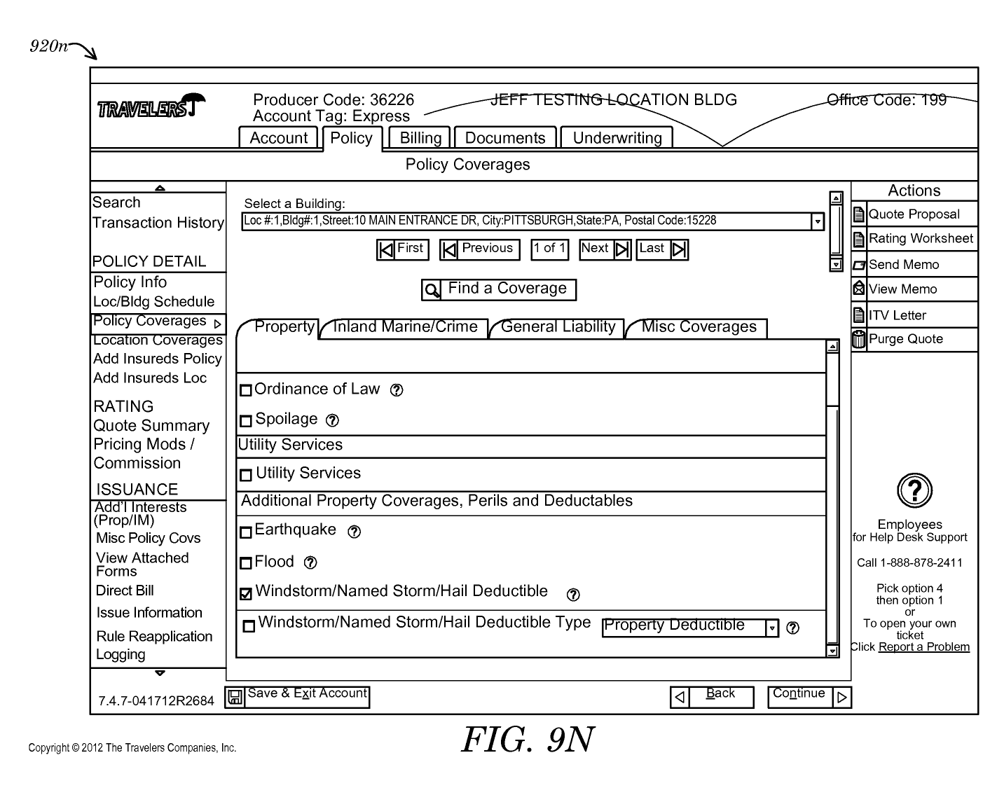

Turning to FIG. 3A, a flow diagram of a method 300 according to some embodiments is shown. In some embodiments, the method 300 may be performed and/or implemented by and/or otherwise associated with one or more specialized and/or computerized processing devices (e.g., the user devices 102a-n, 202 and/or the controller device 104 or smart classification device 204, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the method 300 may be embodied in, facilitated by, and/or otherwise associated with various input mechanisms and/or interfaces such as the interfaces 220, 320, 820a-f, 920a-n of FIG. 2, FIG. 3B, FIG. 8A, FIG. 8B, FIG. 8C, FIG. 8D, FIG. 8E, FIG. 8F, FIG. 9A, FIG. 9B, FIG. 9C, FIG. 9D, FIG. 9E, FIG. 9F, FIG. 9G, FIG. 9H, FIG. 9I, FIG. 9J, FIG. 9K, FIG. 9L, FIG. 9M, and FIG. 9N, herein. In some embodiments, the method 300 may comprise and/or otherwise be associated with one or more of the methods 300, 400, 500, 600, 700 of FIG. 3A, FIG. 4, FIG. 5, FIG. 6, and/or FIG. 7 herein, and/or one or more portions thereof. The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 300 may comprise determining business information at 310, determining a business classification at 315, and/or determining underwriting rules/results/info at 316. In some embodiments, any or all of the information determined at 310, 315, and/or 316 may be received, e.g., from a user and/or user device. According to some embodiments, any or all of the information from 310, 315, and/or 316 may be utilized to define, select, identify, and/or otherwise determine and/or apply product configuration rules logic, at 318. The product configuration rules logic at 318 may, for example, provide automatic determination and display to a user of appropriate options (e.g., deductibles, limits, etc.) from a broader selection of options and/or may eliminate inappropriate options using various input data. In particular, the product configuration rules logic at 318 may receive general business information at 310 (such as coverage needs, location, business type, etc.), business classification information at 315 and/or underwriting rules information at 316 (or results or information) and determine the appropriate product offering (e.g., available coverages, limits, and deductibles) based on risk characteristics (e.g., geographic location of a risk, business classification, legal entity, and/or other risks). In some embodiments, the product configuration rules logic at 318 may be utilized to provide an interface such as the interface 320 depicted in FIG. 3B.

In some embodiments, the product configuration rules logic 318 may utilize the business classification information at 315 and/or latitude/longitude information obtained through geocoding (e.g., the business information from 310 and/or a portion thereof; the ability to place a location at any given point on a map) to execute underwriting strategies (or rules) and create a product offering for the customer, e.g., declining to quote at 326a and/or providing a quote for a specific product at 326b. In some embodiments, users may only be presented with the appropriate coverages, limits, and deductible options that are available to them based on their physical location and underwriting rules. In some embodiments, information descriptive of either or both of the declining of the quote at 326a and the providing of the quote for the specific product at 326b may be utilized to update, adjust, and/or otherwise inform and/or manage the method 300. At 328, for example, logic may be applied to adjust the product configuration rules logic of 318. In such a manner, for example, product configuration options may be further tailored, defined, customized, filtered, and/or provided based on results of previous quotation, underwriting, and/or sales processes (e.g., effectuated via the method 300 and/or iteration thereof).

Referring to FIG. 3B, an example interface 320 according to some embodiments is shown. The interface 320, as depicted in FIG. 3B, is presented depicting a first interface version 320a and a second interface version 320b. The first interface version 320a shows a first type-selection dropdown menu 320-1a from which, for example, a user may select a type of “Windstorm/Named Storm/Hail” deductible. As depicted, the “Windstorm or Hail Percentage” option has been selected. The first interface version 320a may (as depicted) provide a first deductible-selection dropdown menu 320-2a displaying all possible windstorm or hail percentage deductible options (e.g., in accordance with the option selected from the first type-selection dropdown menu 320-1a).

In some embodiments, business classification and/or location information may be utilized to modify the available options as presented via the interface 320. According to some embodiments for example, after the business (or risk's) physical location is entered, the latitude/longitude for the property is identified, thereby removing dependency on state zip code information. The exact physical location of the risk may be cross-checked with the underwriting rules to determine the available terms and conditions for this particular risk. In the second interface version 320b of the interface 320, which may be presented instead of, in place of, and/or provided as an updated version of the first interface version 320a, the deductible options available for selection via a second deductible-selection dropdown menu 320-2b (e.g., in accordance with an option selected from a second type-selection dropdown menu 320-1b) may be limited and/or otherwise selected based on business classification and/or other customer and/or product-specific information. In the second interface version 320b, for example, the user must select either a five percent (5%) or ten percent (10%) deductible, as the lower deductible options do not appear (e.g., are either not presented or have been removed).

Such functionality may, for example, reduce and/or remove the need to use zip codes which have a larger geographic region which may span several risk areas, and permit use of a specific location which allows for more accurate options, and eliminates the need for an underwriter to get involved to set certain policy limits, deductibles, terms, conditions, etc.

Turning to FIG. 4, a flow diagram of a method 400 according to some embodiments is shown. In some embodiments, the method 400 may be performed and/or implemented by and/or otherwise associated with one or more specialized and/or computerized processing devices (e.g., the user devices 102a-n, 202 and/or the controller device 104 or smart classification device 204, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the method 400 may be embodied in, facilitated by, and/or otherwise associated with various input mechanisms and/or interfaces such as the example interfaces 220, 320, 820a-f, 920a-n of FIG. 2, FIG. 3B, FIG. 8A, FIG. 8B, FIG. 8C, FIG. 8D, FIG. 8E, FIG. 8F, FIG. 9A, FIG. 9B, FIG. 9C, FIG. 9D, FIG. 9E, FIG. 9F, FIG. 9G, FIG. 9H, FIG. 9I, FIG. 9J, FIG. 9K, FIG. 9L, FIG. 9M, and FIG. 9N, herein. In some embodiments, the method 400 may comprise and/or otherwise be associated with one or more of the methods 300, 500, 600, 700 of FIG. 3A, FIG. 5, FIG. 6, and/or FIG. 7 herein, and/or one or more portions thereof.

In some embodiments, the method 400 may be descriptive of and/or comprise an enterprise system and/or logic, such as an Automated Modeled Underwriting (AMU) Logic 402 (and/or a portion thereof). In some embodiments, the AMU logic 402 may receive inputs at 410, such as business information. According to some embodiments, the inputs at 410 may be utilized by a Smart Classification logic 412, which may work with a Risk Profile Q/A logic 414, shown collectively as a Classification Logic dashed box 415, such as to identify the proper business classification for the business being evaluated, e.g., as is described in U.S. patent application Ser. No. 13/179,464 entitled “SYSTEMS AND METHODS FOR BUSINESS CLASSIFICATION” filed on Jul. 8, 2011, the business classification concepts and descriptions of which are hereby incorporated herein by reference. In some embodiments, the Classification Logic 415 may not be necessary and/or desired in the method 400. In such embodiments, an agent and/or user may select a business classification and enter it via the AMU logic 402 directly. The business classification may then, for example, be utilized by Underwriting Rules 416 (“U/W Rules”) to validate quote eligibility based on risk characteristics and product selection.

In some embodiments, a result of the Underwriting Rules 416 may be that the customer is declined a quote and the AMU logic 402 may cease further processing, or that the AMU logic 402 continues to Product Configuration Rules 418. The Product Configuration Rules 418, may, in some embodiments, utilize the inputs/Business Information from 410 and/or results from the Classification Logic 415 and/or the Underwriting Rules 416 to determine an appropriate product offering for the customer (e.g., available coverages, limits, and deductibles) based on risk characteristics (e.g., geographic location of the business, business classification, legal entity, and other relevant risk characteristics). A result of the Product Configuration Rules 418 may, in some embodiments, be that the customer is declined a quote and the AMU logic 402 may cease further processing, or that the AMU logic 402 continues to Predictive Model Pricing at 422 to provide a price for the product. The Predictive Model Pricing at 422 may utilize, for example, the inputs/Business Info from 410 and/or results from the Classification Logic 415 and/or the Underwriting Rules 416 and/or the Product Configuration Rules 418, and determine the price (or rate or premium) for the desired coverage for the business by performing predictive model pricing with various risk characteristics (multivariable) to properly price each risk. In some embodiments, the AMU logic 402 may comprise a Customers Like You logic at 424, which determines one or more optional insurance coverages or features for the business policy, based on several factors such as certain coverages/features that are utilized by other customers in the same or similar business area or with the same or similar base insurance policy, and/or based on other factors such as is described in U.S. patent application Ser. No. 13/179,120 entitled “SYSTEMS AND METHODS FOR DETERMINING OPTIONAL INSURANCE COVERAGES”, filed Jul. 8, 2011, the insurance coverage and/or feature factors of which are hereby incorporated by reference herein. In some embodiments, a result of the Customers Like You logic at 424 may be that the customer is declined a quote, the customer is provided with a quote which is available for issue (or AFI), or the quote is referred to an underwriter for further consideration, as indicated by output box 426. The various rules and/or logic components 412, 414, 416, 418, 422, 424 of the method 400 may be performed in any order or sequence that is or becomes desirable and/or practicable, and certain components 412, 414, 416, 418, 422, 424 may be performed concurrently and/or continuously, throughout the AMU logic 402 to provide the desired functionality described herein. In the case that the Customers Like You logic at 424 is not utilized, the outputs at 426 may come directly from the Predictive Model Pricing logic at 422 and/or the appropriate components 412, 414, 416, 418, 422, depending on the order performed (and/or depending upon other preferences and/or configurations).

In some embodiments, information from the outputs at 426 may be utilized to update, adjust, and/or otherwise inform and/or manage the method 400. At 428, for example, logic may be applied to review results (e.g., of the method 400 and/or the AMU logic 402 thereof) and/or adjust one or more of the inputs/Business Information at 410, the Classification Logic 415, the Underwriting Rules 416, the Product Configuration Rules 418, the Predictive Model Pricing logic at 422, and/or the Customers Like You logic at 424. In such a manner, for example, product configuration options may be further tailored, defined, customized, filtered, and/or provided based on results of previous quotation, underwriting, and/or sales processes (e.g., effectuated via the method 400 and/or an iteration thereof)

Turning to FIG. 5, a flow diagram of a method 500 according to some embodiments is shown. In some embodiments, the method 500 may be performed and/or implemented by and/or otherwise associated with one or more specialized and/or computerized processing devices (e.g., the user devices 102a-n, 202 and/or the controller device 104 or smart classification device 204, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the method 500 may be embodied in, facilitated by, and/or otherwise associated with various input mechanisms and/or interfaces such as the example interfaces 220, 320, 820a-f, 920a-n of FIG. 2, FIG. 3B, FIG. 8A, FIG. 8B, FIG. 8C, FIG. 8D, FIG. 8E, FIG. 8F, FIG. 9A, FIG. 9B, FIG. 9C, FIG. 9D, FIG. 9E, FIG. 9F, FIG. 9G, FIG. 9H, FIG. 9I, FIG. 9J, FIG. 9K, FIG. 9L, FIG. 9M, and FIG. 9N, herein. In some embodiments, the method 500 may comprise and/or otherwise be associated with one or more of the methods 300, 400, 600, 700 of FIG. 3A, FIG. 4, FIG. 6, and/or FIG. 7 herein, and/or one or more portions thereof.

In some embodiments, the method 500 may comprise determining policy information, at 510. According to some embodiments, the method 500 may comprise determining first third-party vendor data, at 511a. In some embodiments, the method 500 may comprise smart classification, at 512. According to some embodiments, the method 500 may comprise determining location, address, and/or exposure information, at 511b. In some embodiments, the method 500 may comprise determining second third-party data, at 511c. According to some embodiments, the method 500 may comprise a first product configuration, at 518a. In some embodiments, the method 500 may comprise determining risk profile and/or segment eligibility, at 514. According to some embodiments, the method 500 may comprise a second product configuration, at 518b. In some embodiments, the method 500 may comprise application of automatic underwriting rules, at 516. A determination may be made as to whether the underwriting conditions are acceptable or not, at 517. In the case that the terms are not acceptable, the method 500 may proceed to provide a declination message at 526a. In the case that the terms are determined to be acceptable, the method 500 may proceed to perform Customers Like You logic, at 524. In some embodiments, the method 500 may comprise a third product configuration, at 518c. According to some embodiments, the method 500 may comprise providing a quote for a policy and/or product, at 526b.

Turning to FIG. 6, a flow diagram of a method 600 according to some embodiments is shown. In some embodiments, the method 600 may be performed and/or implemented by and/or otherwise associated with one or more specialized and/or computerized processing devices (e.g., the user devices 102a-n, 202 and/or the controller device 104 or smart classification device 204, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the method 600 may be embodied in, facilitated by, and/or otherwise associated with various input mechanisms and/or interfaces such as the example interfaces 220, 320, 820a-f, 920a-n of FIG. 2, FIG. 3B, FIG. 8A, FIG. 8B, FIG. 8C, FIG. 8D, FIG. 8E, FIG. 8F, FIG. 9A, FIG. 9B, FIG. 9C, FIG. 9D, FIG. 9E, FIG. 9F, FIG. 9G, FIG. 9H, FIG. 9I, FIG. 9J, FIG. 9K, FIG. 9L, FIG. 9M, and FIG. 9N, herein. In some embodiments, the method 400 may comprise and/or otherwise be associated with one or more of the methods 300, 400, 500, 700 of FIG. 3A, FIG. 4, FIG. 5, and/or FIG. 7 herein, and/or one or more portions thereof.

In some embodiments, the method 600 may comprise receiving, selecting, identifying, and/or otherwise determining one or more of policy information at 610, location address data at 611b, third-party verification data at 611c, smart classification data at 612, segment eligibility data at 614a, risk profile data at 614b, and/or Underwriting Questions (“U/W Questions”) at 616. In some embodiments, the method 600 may comprise configuring a product offering, at 618 (e.g., based on any or all of the inputs from 610, 611b-c, 612, 614a-b, 616). Various inputs such as the policy information from 610, the smart classification information from 612, the underwriting question information from 616 (e.g., and/or answers thereto), the segment eligibility information at 614a, the risk profile information at 614b, and/or the location information at 611b (and/or third-party verification data from 611c thereof) may, for example, be utilized at 618 by a product offering configurator (module, device, etc.). In some embodiments, the product offering at 618 may include and/or define available coverages, policy limits, and/or deductible options. According to some embodiments, the method 600 may comprise utilizing the product offering at 618 to provide and/or determine a quoted policy at 626b.

Turning to FIG. 7, a flow diagram of a method 718 according to some embodiments is shown. In some embodiments, the method 718 may be performed and/or implemented by and/or otherwise associated with one or more specialized and/or computerized processing devices (e.g., the user devices 102a-n, 202 and/or the controller device 104 or smart classification device 204, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the method 718 may be embodied in, facilitated by, and/or otherwise associated with various input mechanisms and/or interfaces such as the example interfaces 220, 320, 820a-f, 920a-n of FIG. 2, FIG. 3B, FIG. 8A, FIG. 8B, FIG. 8C, FIG. 8D, FIG. 8E, FIG. 8F, FIG. 9A, FIG. 9B, FIG. 9C, FIG. 9D, FIG. 9E, FIG. 9F, FIG. 9G, FIG. 9H, FIG. 9I, FIG. 9J, FIG. 9K, FIG. 9L, FIG. 9M, and FIG. 9N, herein. In some embodiments, the method 718 may comprise and/or otherwise be associated with one or more of the methods 300, 400, 500, 600 of FIG. 3A, FIG. 4, FIG. 5, and/or FIG. 6 herein, and/or one or more portions thereof.

In some embodiments, the method 718 may comprise performing geocoding, at 711. Address information may be input and/or received, at 711b, for example, and/or processed at 711c-1. The processing at 711c-1 may comprise, in some embodiments, cleansing, standardizing, and/or validating the address input at 711b. The geocoding 711 may further comprise, in some embodiments, utilizing the processed address information to assign a latitude and longitude to the location, at 711c-2.

In some embodiments, the method 718 may comprise utilizing the results of the geocoding at 711 to determine coverage, limit, and/or deductible options, at 718a. Available and/or typical ranges and/or values of such parameters may, for example, be filtered and/or selected based on the geocoding at 711. According to some embodiments, the method 718 may comprise providing one or more product configurations to a user, at 724. The available coverages, limits, and/or deductibles, based on the geocoding at 711, may for example be provided via a user interface (not shown in FIG. 7) such as a menu-driven GUI interface that allows the user to select from within available ranges and or parameter options for the desired product.

Turning now to FIG. 8A, FIG. 8B, FIG. 8C, FIG. 8D, FIG. 8E, and FIG. 8F, example interfaces 820a-f according to some embodiments are shown. In some embodiments, the interfaces 820a-f may comprise a web page, web form, database entry form, API, spreadsheet, table, and/or application or other GUI via which a user may manage, define, select, and/or otherwise interact with product configuration rules for underwriting products. The interfaces 820a-f may, for example, comprise a back-end of an underwriting program and/or platform programmed and/or otherwise configured to execute, conduct, and/or facilitate any of the various methods 300, 400, 500, 600, 700 of FIG. 3A, FIG. 4, FIG. 5, FIG. 6, and/or FIG. 7 and/or portions or combinations thereof described herein. In some embodiments, the interfaces 820a-f may be output via a computerized device such as one or more of the user devices 102a-n, 202 and/or the controller device 104 or the classification device 204, of FIG. 1 and/or FIG. 2 herein. In some embodiments, the example interfaces 820a-f may comprise interface outputs of (and/or otherwise associated with) an API utilized to setup, initialize, define, and/or manage product configuration rules, such as may be implemented and/or provided by the API device 246 of FIG. 2 herein.

A first example interface 820a as depicted in FIG. 8A, for example, may provide a plurality of available selection options such as a Configuration Versions option 820-1, a Coverage Attachment Levels option 820-2, a Lines of Insurance option 820-3, and/or a Coverages option 820-4. In some embodiments, selection of the Configuration Versions option 820-1 (e.g., as depicted in FIG. 8A) may cause the first example interface 820a to display and/or provide a plurality of available rule sets 820-1a from which a user may choose to implement as product configuration guidelines. Each rule set from the plurality of available rules sets 820-1a may, for example, comprise a definition of product configuration parameters that are available, e.g., based on geographic regions and/or specific latitudes and longitudes (or ranges thereof). In some embodiments, the first example interface 820a may be utilized to select, modify, define, and/or otherwise manage any or all rule sets from the plurality of available rules sets 820-1a.

According to some embodiments, a second example interface 820b as depicted in FIG. 8B may be provided. The second example interface 820b may, for example, provide the plurality of selectable options such as the Configuration Versions option 820-1, the Coverage Attachment Levels option 820-2, the Lines of Insurance option 820-3, and/or the Coverages option 820-4. In some embodiments (e.g., as depicted in FIG. 8B), selection of the Coverage Attachment Levels option 820-2 may cause the second example interface 820b to provide and/or display a listing of available attachment levels 820-2a and/or a listing of selected attachment levels 820-2b. In some embodiments, the second example interface 820b may be utilized to select, modify, define, and/or otherwise manage any or all of the available and/or selected attachment levels via either or both of the listing of the available attachment levels 820-2a and/or the listing of the selected attachment levels 820-2b.

In some embodiments, a third example interface 820c as depicted in FIG. 8C may be provided. The third example interface 820c may, for example, provide the plurality of selectable options such as the Configuration Versions option 820-1, the Coverage Attachment Levels option 820-2, the Lines of Insurance option 820-3, and/or the Coverages option 820-4. In some embodiments (e.g., as depicted in FIG. 8C), selection of the Lines of Insurance option 820-3 may cause the third example interface 820c to provide and/or display a listing of available lines of insurance 820-3a and/or a listing of selected lines of insurance 820-3b. In some embodiments, the third example interface 820c may be utilized to select, modify, define, and/or otherwise manage any or all of the available and/or selected lines of insurance via either or both of the listing of the available lines of insurance 820-3a and/or the listing of the selected lines of insurance 820-3b.

According to some embodiments, a fourth example interface 820d as depicted in FIG. 8D may be provided. The fourth example interface 820d may, for example, provide the plurality of selectable options such as the Configuration Versions option 820-1, the Coverage Attachment Levels option 820-2, the Lines of Insurance option 820-3, and/or the Coverages option 820-4. In some embodiments (e.g., as depicted in FIG. 8D), selection of the Coverages option 820-4 may cause the fourth example interface 820d to provide and/or display a listing of available lines of insurance coverages 820-4a and/or a listing of selected lines of insurance coverages 820-4b. In some embodiments, the fourth example interface 820d may be utilized to select, modify, define, and/or otherwise manage any or all of the available and/or selected lines of insurance coverages via either or both of the listing of the available lines of insurance coverages 820-4a and/or the listing of the selected lines of insurance coverages 820-4b. According to some embodiments, the fourth example interface 820d may comprise a Dependency details button 820-4c and/or a View details button 820-4d.

In some embodiments, selection and/or activation of the Dependency details button 820-4c of the fourth example interface 820d may cause a fifth example interface 820e as depicted in FIG. 8E to be provided. The fifth example interface 820e may, for example, provide the plurality of selectable options such as the Configuration Versions option 820-1, the Coverage Attachment Levels option 820-2, the Lines of Insurance option 820-3, and/or the Coverages option 820-4. In some embodiments (e.g., as depicted in FIG. 8E), the fifth example interface 820e may provide and/or display the listing of available lines of insurance coverages 820-4a and/or a listing of selected line of insurance coverage dependencies 820-4e. In some embodiments, the fifth example interface 820e may be utilized to select, modify, define, and/or otherwise manage any or all of the available and/or selected lines of insurance coverages and/or the dependencies thereof via either or both of the listing of the available lines of insurance coverages 820-4a and/or the listing of the selected line of insurance coverage dependencies 820-4e.

According to some embodiments, selection and/or activation of the View details button 820-4d of the fourth example interface 820d may cause a sixth example interface 820f as depicted in FIG. 8F to be provided. The sixth example interface 820f may, for example, provide the plurality of selectable options such as the Configuration Versions option 820-1, the Coverage Attachment Levels option 820-2, the Lines of Insurance option 820-3, and/or the Coverages option 820-4. In some embodiments (e.g., as depicted in FIG. 8F), the sixth example interface 820f may provide and/or display coverage details 820-4f for any available and/or selected line of insurance coverages. In some embodiments, the sixth example interface 820f may be utilized to select, modify, define, and/or otherwise manage any or all of the coverage details 820-4f.

Referring now to FIG. 9A, FIG. 9B, FIG. 9C, FIG. 9D, FIG. 9E, FIG. 9F, FIG. 9G, FIG. 9H, FIG. 9I, FIG. 9J, FIG. 9K, FIG. 9L, FIG. 9M, and FIG. 9N, example interfaces 920a-n according to some embodiments are shown. In some embodiments, the interfaces 920a-n may comprise a web page, web form, database entry form, API, spreadsheet, table, and/or application or other GUI via which an underwriter (or customer or other entity) may enter data to conduct and/or facilitate an underwriting and/or sales process. The interfaces 920a-n may, for example, comprise a front-end of an underwriting program and/or platform programmed and/or otherwise configured to execute, conduct, and/or facilitate any of the various methods 300, 400, 500, 600, 700 of FIG. 3A, FIG. 4, FIG. 5, FIG. 6, and/or FIG. 7 and/or portions or combinations thereof described herein. In some embodiments, the interfaces 920a-n may be output via a computerized device such as one or more of the user devices 102a-n, 202 and/or the controller device 104 or the classification device 204, of FIG. 1 and/or FIG. 2 herein. In some embodiments, the example interfaces 920a-n may comprise interface outputs of (and/or otherwise associated with) an GUI utilized to research, price, quote, purchase/sell, and/or otherwise configure an underwriting product, such as may be implemented and/or provided by the user interface 220 of FIG. 2 herein.

A first example interface 920a as depicted in FIG. 9A, for example, may provide a plurality of available selection and/or fillable options for various location information 920-1. In some embodiments, a smart classification information option 920-2 may be provided. The smart classification information 920-2 may, in some embodiments (such as described herein), comprise an option that utilizes some or all of the location information 920-1 to determine (e.g., utilizing stored data such as third-party data) an appropriate business (and/or other) classification for the insured (e.g., potential insured, customer, potential customer). As shown in the first example interface 920a in FIG. 9A, for example, the address information has been utilized to automatically determine that an appropriate classification for the location is an “Apartment (14 units per fire rating division)”, as depicted in the smart classification option 920-2. In some embodiments, other information such as business metric information 920-3 may be entered and/or selected. In some embodiments, a second example interface 920b as depicted in FIG. 9B may also or alternatively provide for the entry and/or selection of location information 920-1 and/or business information 920-3.

According to some embodiments, a third example interface 920c as depicted in FIG. 9C may provide an alternate view and/or input mechanism (e.g., a confirmation screen) for the location information 920-1 and the smart classification information 920-2. Once a user has confirmed and/or selected appropriate and/or desired metrics and/or approves of the smart classification information 920-2, in some embodiments an eligibility determination button 920-4a may be utilized to initiate a determination of eligibility of the business/customer based on the various entered and/or selected information 920-1, 920-2, 920-3. Selection of the eligibility determination button 920-4a may, for example, cause a fourth example interface 920d as depicted in FIG. 9D to be displayed and/or provided. The fourth example interface 920d may, in some embodiments, provide an eligibility screen 920-4b via which a user may confirm and/or determine eligibility.

In some embodiments, a fifth example interface 920e as depicted in FIG. 9E may also or alternatively provide for the entry and/or selection of location information 920-1 and/or smart classification information 920-2. In some embodiments, an eligibility review button 920-4c may be provided, providing a mechanism for the user to review and/or edit information from the eligibility screen 920-4b. In some embodiments, the fifth example interface 920e may also or alternatively comprise underwriting questions 920-5. In some embodiments, the underwriting questions 920-5 may be generated, selected, and/or presented based on the location information 920-1, smart classification information 920-2, and/or the information from the eligibility screen 920-4b.

According to some embodiments, a sixth example interface 920f as depicted in FIG. 9F may display and/or provide underwriting questions 920-5 and/or coverage information 920-6a. In some embodiments, the coverage information 920-6a that is available for entry and/or selection (e.g., via the depicted drop-down menus and/or pick-lists) may be selected based on the location information 920-1 and/or the smart classification information 920-2. In the case that the smart classification information 920-2 is associated with a stored rule that prohibits a valuation based on anything other than “Replacement Cost”, for example, only the “Replacement Cost” option may be presented as being available for selection and/or entry (e.g., other options may simply not be presented, may be removed from the list, and/or may be ‘grayed-out’ or otherwise depicted as being non-selectable).

In some embodiments, a seventh example interface 920g as depicted in FIG. 9G may also or alternatively display and/or provide the coverage information 920-6a and/or premises information 920-7. According to some embodiments, an eighth example interface 920h as depicted in FIG. 9H may also or alternatively display and/or provide the premises information 920-7 and/or Insurance-To-Value (ITV) information 920-8a. In some embodiments, entry of the ITV information 920-8a may cause a ninth example interface 920i as depicted in FIG. 9I to be displayed and/or provided. The ninth example interface 920i may, for example, comprise an ITV confirmation screen 920-8b that notifies the user of any issues with the ITV information 920-8a and/or provides a mechanism via which the user may edit and/or choose different ITV information 920-8a. In the example of FIG. 9I, for example, the user has selected an amount of insurance that does not cover the full estimated reconstruction costs of the premises and the user is accordingly warned/notified (via the ITV confirmation screen 920-8b) that such an ITV value is not desirable and/or is not considered best-practice.

According to some embodiments, a tenth example interface 920j as depicted in FIG. 9J may comprise a listing or schedule of premises to be insured 920-9. The schedule of premises to be insured 920-9 may, for example, comprise an indication of a set of related database records defining the premises and/or the configuration for the desired underwriting product (e.g., based on the location information 920-1, the smart classification information 920-2, the business metric information 920-3, answers to the underwriting questions 920-5, the selected coverage information 920-6a, the premises information 920-7, and/or the ITV information 920-8a). In some embodiments, an eleventh example interface 920k as depicted in FIG. 9K may comprise an indication of actual coverages and limits 920-6b and/or a quoted premium 920-10. In some embodiments, a twelfth example interface 920l as depicted in FIG. 9L may also or alternatively comprise an indication of the actual coverages and limits 920-6b and/or the quoted premium 920-10. In some embodiments, a thirteenth example interface 920m as depicted in FIG. 9M and/or a fourteenth example interface 920n as depicted in FIG. 9N may be provided to allow a user to search for and/or select various deductible options for the quoted product. According to some embodiments, any or all of the various options presented via the example interface 920a-n may be limited, filtered, and/or selectively populated based on information descriptive of the insured/customer, such as any or all of the location information 920-1 and/or the smart classification (or other classification) information 920-2. In such a manner, for example (and as described herein), the configuration of the product to-be-quoted may be less likely to be rejected by an underwriter and/or may be otherwise more likely to be quickly processed and accepted and/or sold.

While the example interfaces 820a-f, 920a-n are depicted herein with respect to a specific example of an insurance product policy underwriting process, other products, classifications, classification searches, and/or reclassifications may be provided in accordance with some embodiments. While the depicted classification comprises a business classification, for example, classification of other underwriting metrics may also or alternatively be utilized by and/or incorporated into the interfaces 820a-f, 920a-n.

While various components of the interfaces 820a-f, 920a-n have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

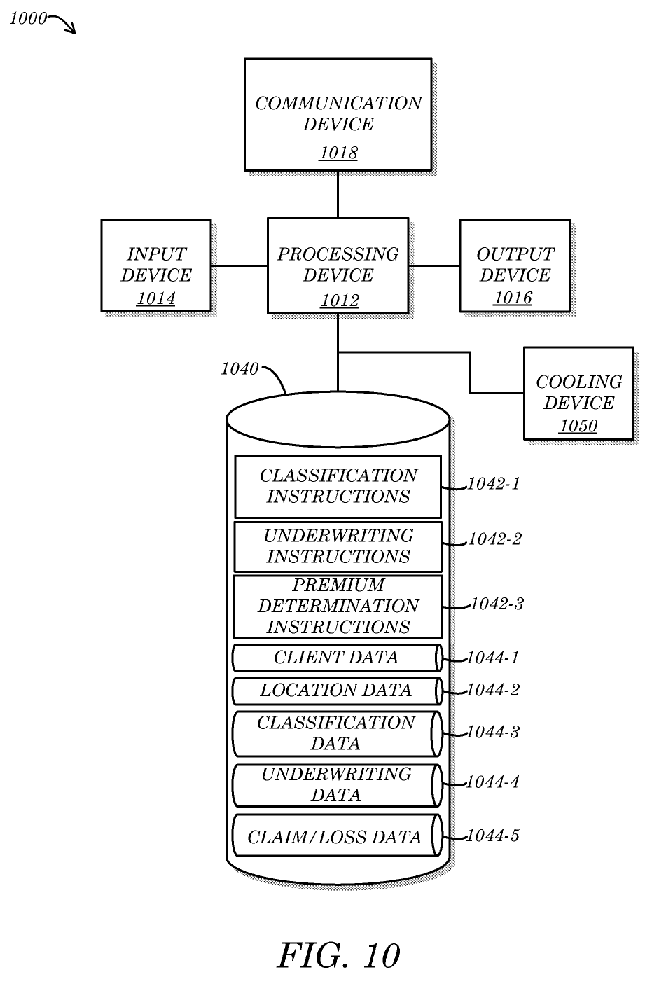

Turning to FIG. 10, a block diagram of an apparatus 1000 according to some embodiments is shown. In some embodiments, the apparatus 1000 may be similar in configuration and/or functionality to user devices 102a-n, 202 and/or the controller device 104 or the classification device 204, of FIG. 1 and/or FIG. 2 herein. The apparatus 1000 may, for example, execute, process, facilitate, and/or otherwise be associated with the methods 300, 400, 500, 600, 700 of FIG. 3A, FIG. 4, FIG. 5, FIG. 6, and/or FIG. 7, and/or may output or provide the interfaces 220, 320, 820a-f, 920a-n of FIG. 2, FIG. 3B, FIG. 8A, FIG. 8B, FIG. 8C, FIG. 8D, FIG. 8E, FIG. 8F, FIG. 9A, FIG. 9B, FIG. 9C, FIG. 9D, FIG. 9E, FIG. 9F, FIG. 9G, FIG. 9H, FIG. 9I, FIG. 9J, FIG. 9K, FIG. 9L, FIG. 9M, and FIG. 9N, herein. In some embodiments, the apparatus 1000 may comprise a processing device 1012, an input device 1014, an output device 1016, a communication device 1018, and/or a memory device 1040. Fewer or more components 1012, 1014, 1016, 1018, 1040 and/or various configurations of the components 1012, 1014, 1016, 1018, 1040 may be included in the apparatus 1000 without deviating from the scope of embodiments described herein.

According to some embodiments, the processing device 1012 may be or include any type, quantity, and/or configuration of electronic and/or computerized processor that is or becomes known. The processing device 1012 may comprise, for example, an Intel® IXP 2800 network processor or an Intel® XEON™ Processor coupled with an Intel® E9501 chipset. In some embodiments, the processing device 1012 may comprise multiple inter-connected processors, microprocessors, and/or micro-engines. According to some embodiments, the processing device 1012 (and/or the apparatus 1000 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 1000 comprises a server such as a blade server, necessary power may be supplied via a standard AC outlet, power strip, surge protector, and/or Uninterruptible Power Supply (UPS) device.

In some embodiments, the input device 1014 and/or the output device 1016 are communicatively coupled to the processing device 1012 (e.g., via wired and/or wireless connections, traces, and/or pathways) and they may generally comprise any types or configurations of input and output components and/or devices that are or become known, respectively. The input device 1014 may comprise, for example, a keyboard that allows an operator of the apparatus 1000 to interface with the apparatus 1000 (e.g., an underwriter, such as to implement and/or interact with embodiments herein to underwrite, quote, and/or sell underwriting products). The output device 1016 may, according to some embodiments, comprise a display screen and/or other practicable output component and/or device. The output device 1016 may, for example, provide product underwriting configurations, guidance, benchmarks, and/or quotes (e.g., via a website and/or via a computer workstation). According to some embodiments, the input device 1014 and/or the output device 1016 may comprise and/or be embodied in a single device such as a touch-screen monitor.

In some embodiments, the communication device 1018 may comprise any type or configuration of communication device that is or becomes known or practicable. The communication device 1018 may, for example, comprise a Network Interface Card (NIC), a telephonic device, a cellular network device, a router, a hub, a modem, and/or a communications port or cable. In some embodiments, the communication device 1018 may be coupled to provide data to a customer device, such as in the case that the apparatus 1000 is utilized to provide underwriting product quotations and/or sales. According to some embodiments, the communication device 1018 may also or alternatively be coupled to the processing device 1012. In some embodiments, the communication device 1018 may comprise an Infrared Radiation (IR), RF, Bluetooth™, and/or Wi-Fi® network device coupled to facilitate communications between the processing device 1012 and another device (such as a customer device and/or a third-party device).

The memory device 1040 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 1040 may, according to some embodiments, store one or more of classification instructions 1042-1, underwriting instructions 1042-2, and/or premium determination instructions 1042-3. In some embodiments, the classification instructions 1042-1, underwriting instructions 1042-2, and/or premium determination instructions 1042-3 may be utilized by the electronic processor 1012 to provide output information via the output device 1016 and/or the communication device 1018.

According to some embodiments, the classification instructions 1042-1 may be operable to cause the processing device 1012 to access and/or process client data 1044-1, location data 1044-2, classification data 1044-3, underwriting data 1044-4, and/or claim/loss data 1044-5, as described herein (e.g., in accordance with the methods 300, 400, 500, 600, 700 of FIG. 3A, FIG. 4, FIG. 5, FIG. 6, and/or FIG. 7 herein). Client data 1044-1, location data 1044-2, classification data 1044-3, underwriting data 1044-4, and/or claim/loss data 1044-5 received via the input device 1014 and/or the communication device 1018 may, for example, be analyzed, sorted, filtered, decoded, decompressed, ranked, scored, plotted, and/or otherwise processed by the processing device 1012 in accordance with the classification instructions 1042-1. In some embodiments, client data 1044-1, location data 1044-2, classification data 1044-3, underwriting data 1044-4, and/or claim/loss data 1044-5 may be fed by the processing device 1012 through one or more mathematical and/or statistical formulas, rule sets, policies, and/or models in accordance with the classification instructions 1042-1 to determine one or more business (and/or other) classifications (and/or reclassifications) that may then be utilized to facilitate product configuration and/or underwriting as described herein.

According to some embodiments, the underwriting instructions 1042-2 may be operable to cause the processing device 1012 to access and/or process client data 1044-1, location data 1044-2, classification data 1044-3, underwriting data 1044-4, and/or claim/loss data 1044-5, as described herein (e.g., in accordance with the methods 300, 400, 500, 600, 700 of FIG. 3A, FIG. 4, FIG. 5, FIG. 6, and/or FIG. 7 herein). Client data 1044-1, location data 1044-2, classification data 1044-3, underwriting data 1044-4, and/or claim/loss data 1044-5 received via the input device 1014 and/or the communication device 1018 may, for example, be analyzed, sorted, filtered, decoded, decompressed, ranked, scored, plotted, and/or otherwise processed by the processing device 1012 in accordance with the underwriting instructions 1042-2. In some embodiments, client data 1044-1, location data 1044-2, classification data 1044-3, underwriting data 1044-4, and/or claim/loss data 1044-5 may be fed by the processing device 1012 through one or more mathematical and/or statistical formulas, rule sets, policies, and/or models in accordance with the underwriting instructions 1042-2 to determine one or more underwriting questions, criteria, and/or requirements that may then be utilized to facilitate product configuration and/or underwriting as described herein.

According to some embodiments, the premium determination instructions 1042-3 may be operable to cause the processing device 1012 to access and/or process client data 1044-1, location data 1044-2, classification data 1044-3, underwriting data 1044-4, and/or claim/loss data 1044-5, as described herein (e.g., in accordance with the methods 300, 400, 500, 600, 700 of FIG. 3A, FIG. 4, FIG. 5, FIG. 6, and/or FIG. 7 herein). Client data 1044-1, location data 1044-2, classification data 1044-3, underwriting data 1044-4, and/or claim/loss data 1044-5 received via the input device 1014 and/or the communication device 1018 may, for example, be analyzed, sorted, filtered, decoded, decompressed, ranked, scored, plotted, and/or otherwise processed by the processing device 1012 in accordance with the premium determination instructions 1042-3 In some embodiments, client data 1044-1, location data 1044-2, classification data 1044-3, underwriting data 1044-4, and/or claim/loss data 1044-5 may be fed by the processing device 1012 through one or more mathematical and/or statistical formulas, rule sets, policies, and/or models in accordance with the premium determination instructions 1042-3 to determine a rate quote that may then be utilized to facilitate product configuration and/or underwriting and/or sales as described herein.

In some embodiments, the memory device 1040 may store the claim/loss data 1044-5. The claim/loss data 1044-5 may, for example, comprise data obtained from determining loss information such as may be based on one or more loss and/or default events associated with a customer and/or product. The claim/loss data 1044-5 may, according to some embodiments, be utilized to update, modify, and/or otherwise influence or affect the various calculations and/or processes described herein. The input device 1014 and/or the communication device 1018 may receive the claim/loss data 1044-5, which may be stored (as depicted in FIG. 10) by the memory device 1040 and/or which may be processed by the processing device 1012 in accordance with stored instructions (not explicitly shown in FIG. 10), such as to modify one or more of the classification instructions 1042-1, the underwriting instructions 1042-2, and/or the premium determination instructions 1042-3.

According to some embodiments, the apparatus 1000 may generally function as a computer terminal and/or server of an insurance and/or surety underwriting company, for example, which is utilized to process various insurance, surety, and/or other underwriting product applications. In some embodiments, the apparatus 1000 may comprise a web server and/or other portal (e.g., an Interactive Voice Response Unit (IVRU)) that provides underwriting and/or product configuration and/or pricing information to customers and/or third-parties.

Any or all of the exemplary instructions and data types described herein and other practicable types of data may be stored in any number, type, and/or configuration of memory devices that is or becomes known. The memory device 1040 may, for example, comprise one or more data tables or files, databases, table spaces, registers, and/or other storage structures. In some embodiments, multiple databases and/or storage structures (and/or multiple memory devices 1040) may be utilized to store information associated with the apparatus 1000. According to some embodiments, the memory device 1040 may be incorporated into and/or otherwise coupled to the apparatus 1000 (e.g., as shown) or may simply be accessible to the apparatus 1000 (e.g., externally located and/or situated).

In some embodiments, the apparatus 1000 may comprise a cooling device 1050. According to some embodiments, the cooling device 1050 may be coupled (physically, thermally, and/or electrically) to the processing device 1012 and/or to the memory device 1040. The cooling device 1050 may, for example, comprise a fan, heat sink, heat pipe, radiator, cold plate, and/or other cooling component or device or combinations thereof, configured to remove heat from portions or components of the apparatus 1000

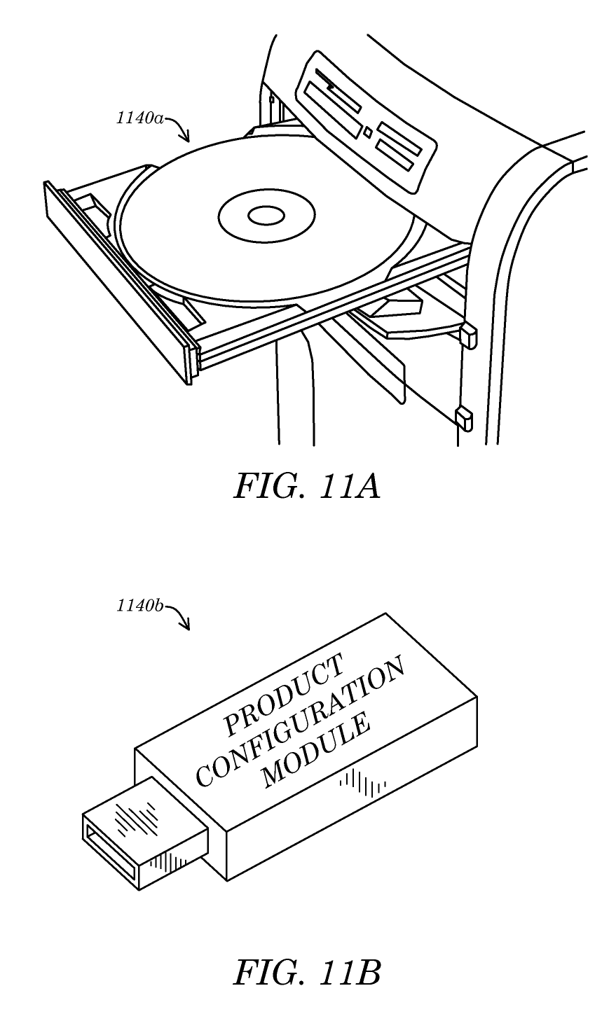

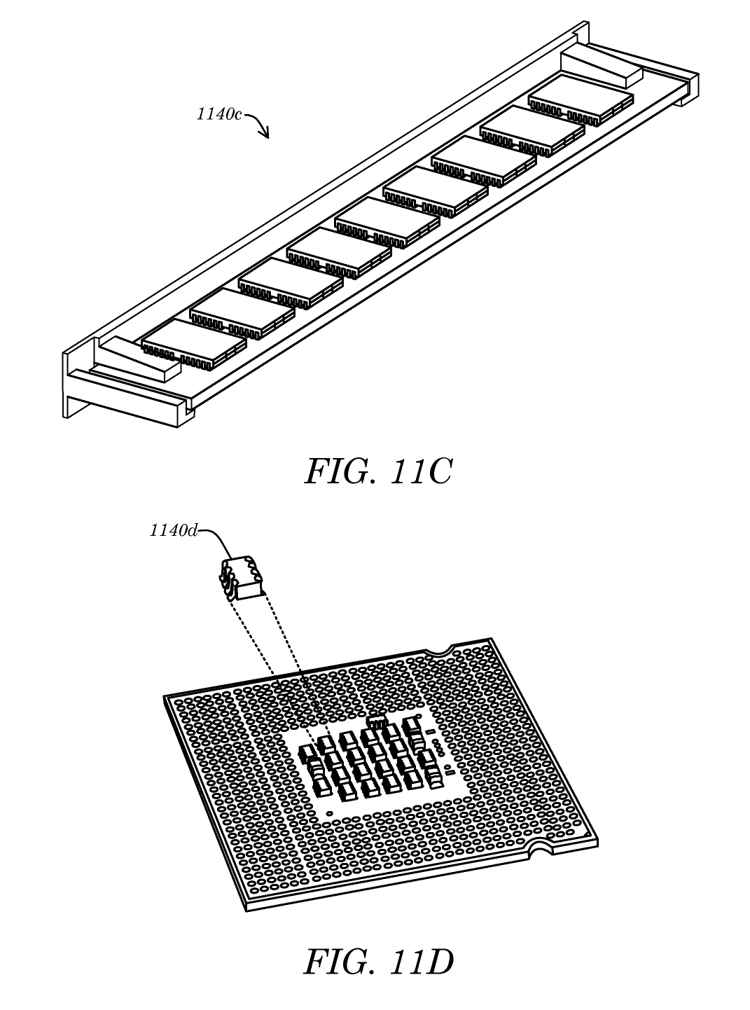

Referring to FIG. 11A, FIG. 11B, FIG. 11C, and FIG. 11D, perspective diagrams of exemplary data storage devices 1140a-d according to some embodiments are shown. The data storage devices 1140a-d may, for example, be utilized to store instructions and/or data such as the classification instructions 1042-1, the underwriting instructions 1042-2, and/or the premium determination instructions 1042-3, each of which is described in reference to FIG. 10 herein. In some embodiments, instructions stored on the data storage devices 1140a-d may, when executed by a processor (such as the processing device 1012 of FIG. 10), cause the implementation of and/or facilitate any of the various methods 300, 400, 500, 600, 700 of FIG. 3A, FIG. 4, FIG. 5, FIG. 6, and/or FIG. 7 described herein. The data storage devices 1140a-d may also or alternatively store data such as the client data 1044-1, the location data 1044-2, the classification data 1044-3, the underwriting data 1044-4, and/or the claim/loss data 1044-5, all as described with reference to FIG. 10 herein.

According to some embodiments, the first data storage device 1140a may comprise a CD, CD-ROM, DVD, Blu-Ray™ Disc, and/or other type of optically-encoded disk and/or other computer-readable storage medium that is or becomes know or practicable. In some embodiments, the second data storage device 1140b may comprise a USB keyfob, dongle, and/or other type of flash memory data storage device that is or becomes know or practicable. According to some embodiments, the third data storage device 1140c may comprise RAM of any type, quantity, and/or configuration that is or becomes practicable and/or desirable. In some embodiments, the third data storage device 1140c may comprise an off-chip cache such as a Level 2 (L2) or Level 3 (L3) cache memory device. According to some embodiments, the fourth data storage device 1140d may comprise an on-chip memory device such as a Level 1 (L1) cache memory device.

The data storage devices 1140a-d may generally store program instructions, code, and/or modules that, when executed by an electronic and/or computerized processing device cause a particular machine to function in accordance with embodiments described herein. In some embodiments, the data storage devices 1140a-d depicted in FIG. 11A, FIG. 11B, FIG. 11C, and FIG. 11D are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

Some embodiments described herein are associated with a “user device” or a “network device”. As used herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
receiving, by a specially-programmed computerized processing device and from a user device, an indication of location information of a business for which an underwriting product is sought;
determining, by the specially-programmed computerized processing device and based on third-party data, a longitude and latitude of the business;
determining, by the specially-programmed computerized processing device and based on the longitude and latitude of the business, one or more product configuration parameters; and
providing, by the specially-programmed computerized processing device and to the user device, an indication of the one or more product configuration parameters.

2. The method of claim 1, further comprising:
receiving an indication of a selection of at least one of the one or more product configuration parameters; and
causing a sale of the underwriting product, the underwriting product being at least partially defined by the at least one of the one or more product configuration parameters.

3. The method of claim 1, wherein the one or more product configuration parameters are selected as a subset from a set of available product configuration parameters.

4. The method of claim 3, wherein the one or more product configuration parameters comprise a deductible level parameter.

5. The method of claim 1, wherein the one or more product configuration parameters are selected based on a risk metric stored in association with the longitude and latitude of the business.

6. The method of claim 1, wherein the providing comprises causing a graphical user interface to present selectable options representing the one or more product configuration parameters.

7. The method of claim 1, wherein the providing comprises causing a graphical user interface to be modified by removing selectable options representing product configuration parameters other than the one or more product configuration parameters.

8. The method of claim 1, wherein the determining, based on the longitude and latitude of the business, of the one or more product configuration parameters, comprises:
defining a set of product configuration rules applicable to one or more geographical areas;
determining that the longitude and latitude of the business is within the one or more geographical areas; and
applying, based on the determination that the longitude and latitude of the business is within the one or more geographical areas, the set of product configuration rules to the underwriting product sought for the business.

9. An apparatus, comprising:
a processing device; and
a memory device in communication with the processing device, the memory device storing instructions that when executed by the processing device result in:
receiving, from a user device, an indication of location information of a business for which an underwriting product is sought;
determining, based on third-party data, a longitude and latitude of the business;
determining, based on the longitude and latitude of the business, one or more product configuration parameters; and
providing, to the user device, an indication of the one or more product configuration parameters.

10. The apparatus of claim 9, wherein the instructions, when executed by the processing device, further result in:
receiving an indication of a selection of at least one of the one or more product configuration parameters; and
causing a sale of the underwriting product, the underwriting product being at least partially defined by the at least one of the one or more product configuration parameters.

11. The apparatus of claim 9, wherein the one or more product configuration parameters are selected as a subset from a set of available product configuration parameters.

12. The apparatus of claim 11, wherein the one or more product configuration parameters comprise a deductible level parameter.

13. The apparatus of claim 9, wherein the one or more product configuration parameters are selected based on a risk metric stored in association with the longitude and latitude of the business.

14. The apparatus of claim 9, wherein the providing comprises causing a graphical user interface to present selectable options representing the one or more product configuration parameters.

15. The apparatus of claim 9, wherein the providing comprises causing a graphical user interface to be modified by removing selectable options representing product configuration parameters other than the one or more product configuration parameters.

16. The apparatus of claim 9, wherein the determining, based on the longitude and latitude of the business, of the one or more product configuration parameters, comprises:
defining a set of product configuration rules applicable to one or more geographical areas;
determining that the longitude and latitude of the business is within the one or more geographical areas; and
applying, based on the determination that the longitude and latitude of the business is within the one or more geographical areas, the set of product configuration rules to the underwriting product sought for the business.

17. A non-transitory computer-readable medium storing instructions that when executed by a processing device result in:
receiving, from a user device, an indication of location information of a business for which an underwriting product is sought;
determining, based on third-party data, a longitude and latitude of the business;
determining, based on the longitude and latitude of the business, one or more product configuration parameters; and
providing, to the user device, an indication of the one or more product configuration parameters.

18. The non-transitory computer-readable medium of claim 17, wherein the instructions, when executed by the processing device, further result in:
receiving an indication of a selection of at least one of the one or more product configuration parameters; and
causing a sale of the underwriting product, the underwriting product being at least partially defined by the at least one of the one or more product configuration parameters.

19. The non-transitory computer-readable medium of claim 17, wherein the one or more product configuration parameters are selected as a subset from a set of available product configuration parameters.

20. The non-transitory computer-readable medium of claim 19, wherein the one or more product configuration parameters comprise a deductible level parameter.

21. The non-transitory computer-readable medium of claim 17, wherein the one or more product configuration parameters are selected based on a risk metric stored in association with the longitude and latitude of the business.

22. The non-transitory computer-readable medium of claim 17, wherein the providing comprises causing a graphical user interface to present selectable options representing the one or more product configuration parameters.

23. The non-transitory computer-readable medium of claim 17, wherein the providing comprises causing a graphical user interface to be modified by removing selectable options representing product configuration parameters other than the one or more product configuration parameters.

24. The non-transitory computer-readable medium of claim 17, wherein the determining, based on the longitude and latitude of the business, of the one or more product configuration parameters, comprises:
defining a set of product configuration rules applicable to one or more geographical areas;
determining that the longitude and latitude of the business is within the one or more geographical areas; and
applying, based on the determination that the longitude and latitude of the business is within the one or more geographical areas, the set of product configuration rules to the underwriting product sought for the business.
